(19) United States
(12) Patent Application Publication
(10) Pub. No.: US 2025/0355380 A1
(43) Pub. Date: Nov. 20, 2025

(54) TWO-COMPONENT DEVELOPER

(71) Applicant: CANON KABUSHIKI KAISHA, Tokyo (JP)

(72) Inventors: RYUICHIRO MATSUO, Ibaraki (JP); ICHIRO KANNO, Chiba (JP); TORU TAKAHASHI, Ibaraki (JP); HITOSHI SANO, Chiba (JP); MARI KABURAGI, Chiba (JP); YUYA CHIMOTO, Chiba (JP); HAYATO IDA, Ibaraki (JP)

(21) Appl. No.: 19/206,575

(22) Filed: May 13, 2025

(30) Foreign Application Priority Data
May 15, 2024 (JP) 2024-079335

(51) Int. Cl. G03G 9/107; G03G 9/08; G03G 9/093

(52) U.S. Cl. CPC G03G 9/108; G03G 9/0819; G03G 9/09342

(57) ABSTRACT

A two-component developer includes a toner and a magnetic carrier. The magnetic carrier includes a magnetic carrier core and a resin coated layer that covers a surface of the magnetic carrier core. The toner includes a composite particle on a surface of a toner particle. The composite particle includes a fine particle A that uses, as a binder component, an organic silicon compound having a siloxane bond. A fine particle B is present on a surface of the composite particle in a state of being partially embedded in a surface of the fine particle A. An average value of an embedment ratio of the fine particle B is 30% or greater and 90% or less. The composite particle is formed of a primary particle having a number average particle diameter of 0.03 μm or greater and 0.30 μm or less.

### BACKGROUND

### Technical Field

The present disclosure relates to a two-component developer used in an image forming method for visualizing an electrostatic charge image using an electrophotographic method.

### Description of the Related Art

In the related art, a method of forming an electrostatic latent image on an electrostatic latent image-bearing member using various methods and attaching a toner to this electrostatic charge image to develop the electrostatic latent image has been typically used as an electrophotographic image forming method. In such development, a two-component development method of mixing carrier particles, referred to as magnetic carriers, with a toner, triboelectrically charging the mixture so that an appropriate amount of a positive or negative electric charge is applied to the toner, and performing development using this electric charge as a driving force has been widely employed.

Since the two-component development method enables functions such as stirring, transporting, and charging of a developer to be imparted to magnetic carriers, the division of functions between the magnetic carriers and the toner is clear. Therefore, the two-component development method has advantages such as satisfactory controllability of developer performance.

Meanwhile, in recent years, with the advancement of technologies in the field of electrophotography, there has been an increasingly strict demand for apparatuses to operate at a high speed and to have a long life as well as high definition and a stabilized image quality. In order to respond to such a demand, a two-component developer is required to have high performance.

A toner that suppresses adverse effects in an image, such as white spots, even in a case of long-term use and thus exhibits excellent image stability and more excellent fixability has been suggested as a toner for achieving the above-described two-component developer (Japanese Patent Laid-Open No. 2016-139063). This toner has, on the toner surface, organic-inorganic composite particles with a surface on which a plurality of protrusions are formed.

However, in the toner described in Japanese Patent Laid-Open No. 2016-139063, variation may occur in charge-imparting performance of a magnetic carrier during long-term use due to transfer of composite particles having a biased surface electric charge to the magnetic carrier surface. In a case where variation occurs in the charge-imparting performance of the magnetic carrier, the charge amount distribution of the two-component developer is broad, and thus image-density irregularities occur. This disadvantage is likely to occur in a case where the image ratio is high or printing is performed on large size paper.

### SUMMARY

The present disclosure provides a two-component developer that addresses the above-described disadvantages.

The present inventors have found that when the following two-component developer is used, adverse effects in an image, such as white spots, can be suppressed even in a case of long-term use and thus excellent image stability can be obtained, and image-density irregularities are suppressed and thus an image with high on-surface uniformity can be stably obtained.

That is, there is provided a two-component developer including: a toner; and a magnetic carrier, in which the magnetic carrier includes a magnetic carrier core and a resin coated layer that covers a surface of the magnetic carrier core, and the resin coated layer has at least one structure selected from structures represented by Formulae (A), (B), and (C),

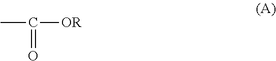

(in Formula (A), R represents an alkyl group having 1 or more and 10 or less carbon atoms),

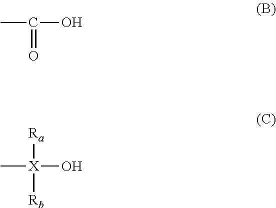

(in Formula (C), X represents a carbon atom or a silicon atom, and Rₐ and R_{b} each independently represent a hydrogen atom or an alkyl group having 1 or more and 10 or less carbon atoms),
the toner is a toner including a composite particle on a surface of a toner particle, the composite particle includes: a fine particle A that uses, as a binder component, an organic silicon compound having a siloxane bond, and a fine particle B that is present in a state of being partially embedded in a surface of the fine particle A, the composite particle is formed of a primary particle having a number average particle diameter of 0.03 μm or greater and 0.30 μm or less, in DD-MAS measurement of solid-state ²⁹Si-NMR of the fine particle A, in a case where a proportion of silicon atoms present in a state of the following unit (a) in all silicon atoms is defined as Xa (%), a proportion of silicon atoms present in a state of the following unit (b) in all silicon atoms is defined as Xb (%), and a proportion of silicon atoms present in a state of the following unit (c) is defined as Xc (%), content proportions of Xa, Xb, and Xc satisfy Expressions (1) and (2),

$$Xa + Xb + Xc \geq 80 \% \qquad ( 1 )$$

$$Xb + Xc \geq 30 \% \qquad ( 2 )$$

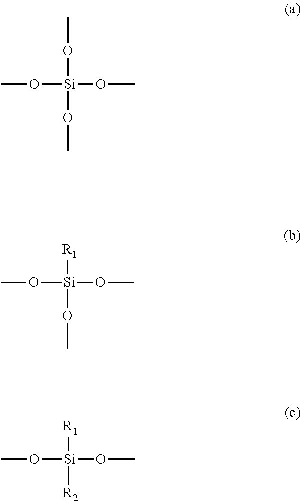

(in Formulae (b) and (c), R₁ and R₂ each independently represent an alkyl group having 1 or more and 6 or less carbon atoms),
in the fine particle B of the composite particle, an average value of an embedment ratio represented by the following equation is 30% or greater and 90% or less,

$$e mbedment ratio ( \% ) of fine particle B = ( depth of fine particle B embedded in fine particle A / diameter of fine particle B ) \times 100$$

in DD-MAS measurement of solid-state ²⁹Si-NMR of the composite particle, a peak PD1 corresponding to a silicon atom represented by Si^{a} in a structure represented by Formula (3), a peak PT1 corresponding to a silicon atom represented by Si^{b} in a structure represented by Formula (4), a peak PT2 corresponding to a silicon atom represented by Si^{c} in a structure represented by Formula (5), a peak PQ1 corresponding to a silicon atom represented by Si^{d} in a structure represented by Formula (6), a peak PQ2 corresponding to a silicon atom represented by Si^{e} in a structure represented by Formula (7), and a peak PQ3 corresponding to a silicon atom represented by Si^{f} in a structure represented by Formula (8) are observed, and in a case where an area of the peak PD1 is defined as SD1, an area of the peak PT1 is defined as ST1, an area of the peak PT2 is defined as ST2, an area of the peak PQ1 is defined as SQ1, an area of the peak PQ2 is defined as SQ2, an area of the peak PQ3 is defined as SQ3, and an area of all peaks corresponding to all silicon atoms is defined as SSi, Expression (9) is satisfied,

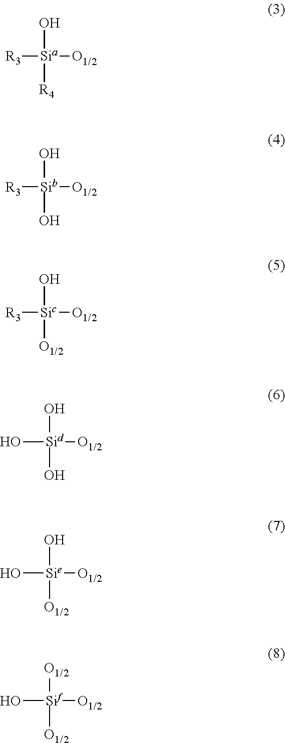

(in Formulae (3) to (5), R₃ and R₄ each independently represent an alkyl group having 1 or more and 6 or less carbon atoms).

$$0.1 \leq \frac{SD 1}{SSi} + \frac{2 \times ST 1}{SSi} + \frac{ST 2}{SSi} + \frac{3 \times SQ 1}{SSi} + \frac{2 \times SQ 2}{SSi} + \frac{SQ 3}{SSi} \leq 0.3 \qquad ( 9 )$$

Further features of the present disclosure will become apparent from the following description of exemplary embodiments.

### DESCRIPTION OF THE EMBODIMENTS

In the present disclosure, the description of a numerical range of “OO or greater and XX or less” or “OO to XX” denotes a numerical range including the endpoints as the lower limit and the upper limit unless otherwise specified. In the present disclosure, the term “(meth)acrylic acid ester” denotes acrylic acid ester and/or methacrylic acid ester. Establishing process and significance of present disclosure

A magnetic carrier in a two-component developer according to the present disclosure includes a magnetic carrier core and a resin coated layer that covers a surface of the magnetic carrier core, and the resin coated layer has at least one structure selected from the group consisting of a structure represented by Formula (A), a structure represented by Formula (B), and a structure represented by Formula (C).

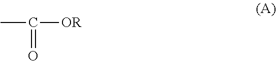

(In Formula (A), R represents an alkyl group having 1 or more and 10 or less carbon atoms.)

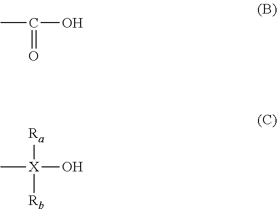

(In Formula (C), X represents a carbon atom or a silicon atom, and Rₐ and R_{b} each independently represent a hydrogen atom or an alkyl group having 1 or more and 10 or less carbon atoms.)

Further, the toner of the present disclosure is a toner including a composite particle on a surface of a toner particle.

The composite particle includes a fine particle A (i) that uses, as a binder component, an organic silicon compound having a siloxane bond, and a fine particle B (ii) that is present in a state of being partially embedded in a surface of the fine particle A.

Further, the composite particle is formed of a primary particle having a number average particle diameter of 0.03 μm or greater and 0.30 μm or less.

In DD-MAS measurement of solid-state ²⁹Si-NMR of the fine particle A, in a case where a proportion of silicon atoms present in a state of the following unit (a) in all silicon atoms is defined as Xa (%), a proportion of silicon atoms present in a state of the following unit (b) in all silicon atoms is defined as Xb (%), and a proportion of silicon atoms present in a state of the following unit (c) is defined as Xc (%), content proportions of Xa, Xb, and Xc satisfy Expressions (1) and (2).

$$Xa + Xb + Xc \geq 80 \% \qquad ( 1 )$$

$$Xb + Xc \geq 30 \% \qquad ( 2 )$$

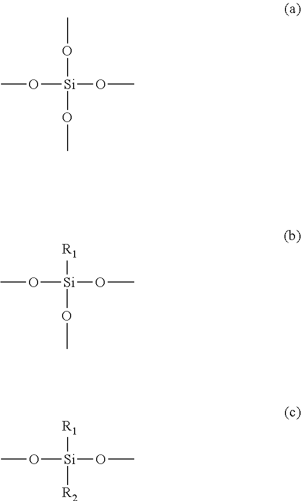

(In Formulae (b) and (c), R₁ and R₂ each independently represent an alkyl group having 1 or more and 6 or less carbon atoms.)

In the fine particle B of the composite particle, an average value of an embedment ratio represented by the following equation is 30% or greater and 90% or less.

$$Embedment ratio ( \% ) of fine particle B = ( depth of fine particle B embedded in fine particle A / diameter of fine particle B ) \times 100$$

Further, in DD-MAS measurement of solid-state ²⁹Si-NMR of the composite particle, a peak PD1 corresponding to a silicon atom represented by Si^{a} in a structure represented by Formula (3), a peak PT1 corresponding to a silicon atom represented by Si^{b} in a structure represented by Formula (4), a peak PT2 corresponding to a silicon atom represented by Si^{c} in a structure represented by Formula (5), a peak PQ1 corresponding to a silicon atom represented by Si^{d} in a structure represented by Formula (6), a peak PQ2 corresponding to a silicon atom represented by Si^{e} in a structure represented by Formula (7), and a peak PQ3 corresponding to a silicon atom represented by Si^{f} in a structure represented by Formula (8) are observed, and in a case where an area of the peak PD1 is defined as SD1, an area of the peak PT1 is defined as ST1, an area of the peak PT2 is defined as ST2, an area of the peak PQ1 is defined as SQ1, an area of the peak PQ2 is defined as SQ2, an area of the peak PQ3 is defined as SQ3, and an area of all peaks corresponding to all silicon atoms is defined as SSi, Expression (9) is satisfied. Further, “O_{1/2}” in Formulae (3) to (8) denotes that a target oxygen atom is bonded to two silicon atoms (one silicon atom is not described).

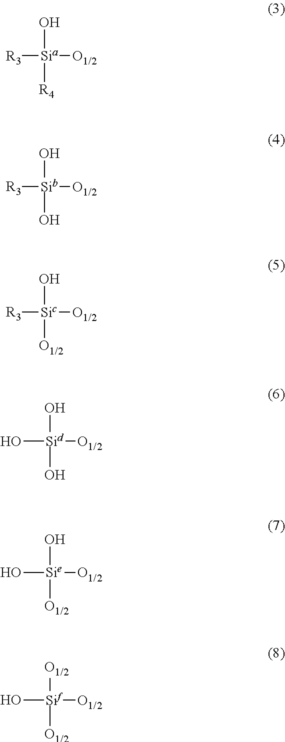

(In Formulae (3) to (5), R₃ and R₄ each independently represent an alkyl group having 1 or more and 6 or less carbon atoms.)

$$0.1 \leq \frac{SD 1}{SSi} + \frac{2 \times ST 1}{SSi} + \frac{ST 2}{SSi} + \frac{3 \times SQ 1}{SSi} + \frac{2 \times SQ 2}{SSi} + \frac{SQ 3}{SSi} \leq 0.3 \qquad ( 9 )$$

The mechanism by which the two-component developer of the present disclosure can address the disadvantage is considered to be as follows.

The toner constituting the two-component developer of the present disclosure includes composite particles on the surface of toner particles. The composite particles include fine particles B present in a state of being partially embedded in the surface of fine particles A. In addition, the fine particles A constituting the composite particles have specific structures represented by Formulae (a) to (c) in the above-described proportions. Further, the composite particles satisfy the relationship represented by Expression (9).

Meanwhile, the magnetic carrier constituting the two-component developer of the present disclosure includes a resin coated layer on the surface of the magnetic carrier core. Further, the resin coated layer has a specific structure having polarity.

Typically, transfer of composite particles from the surface of toner particles to the surface of magnetic carriers or other members is suppressed even in a case of long-term use by using composite particles having a surface with protrusions. When the transfer is suppressed, deterioration of a toner in a two-component developer can be suppressed, and as a result, adverse effects in an image, such as white spots, can be suppressed. Therefore, excellent image stability can be obtained. However, some of the composite particles are transferred to the surface of the magnetic carriers in a case of long-term use. Variation may occur in the charge-imparting performance of the magnetic carriers in a case of long-term use due to the transfer of the composite particles having a biased surface electric charge to the surface of the magnetic carriers. In a case where variation occurs in the charge-imparting performance of the magnetic carriers, the charge amount distribution of the two-component developer is broad, image-density irregularities occur, and the on-surface uniformity is decreased.

In this configuration of the present disclosure, the fine particles A constituting the composite particles present on the surface of the toner particles and the resin coated layer present on the surface of the magnetic carrier core each have a specific structure as described above. Since these structures each have polarity, even in a case where the composite particles having protrusions on which the electric charge is concentrated are transferred to the surface of the magnetic carriers, the polar portion of the fine particles A and the polar portion of the resin coated layer interact with each other, and thus the electric charge concentrated on the protrusions is considered to be diffused into the resin coated layer through these polar groups. As a result, it is assumed that variation in the charge-imparting performance of the surface of the magnetic carriers is suppressed, the charge amount distribution of the two-component developer is suppressed from being broad, image density irregularities in a printed image are suppressed from occurring even in a case of long-term use, and therefore, an image with high on-surface uniformity can be stably obtained.

### Main Configuration of Present Disclosure

From the viewpoint of suppressing occurrence of white spots and improving the on-surface uniformity, the two-component developer of the present disclosure can satisfy Expression (9) in a range of 0.10 or greater and 0.30 or less. When Expression (9) is in the above-described range, the polar portions of the composite particles transferred to the surface of the magnetic carrier and the polar portions of the resin coated layer on the surface of the magnetic carrier core appropriately interact with each other, the electric charge concentrated on the protrusions of the composite particles is diffused into the resin coated layer, and thus the on-surface uniformity is increased. Further, the variation in the charge-imparting performance of the surface of the magnetic carriers can be suppressed, and satisfactory on-surface uniformity can be maintained. From the viewpoint of further suppressing occurrence of white spots and improving the on-surface uniformity, the two-component developer can satisfy Expression (10).

$$0.17 \leq \frac{SD 1}{SSi} + \frac{2 \times ST 1}{SSi} + \frac{ST 2}{SSi} + \frac{3 \times SQ 1}{SSi} + \frac{2 \times SQ 2}{SSi} + \frac{SQ 3}{SSi} \leq 0.3 \qquad ( 10 )$$

From the viewpoint of suppressing occurrence of white spots and improving the on-surface uniformity, the fine particles B are present in a state of partially embedded in the surface of the fine particles A, and the average value of the embedment ratios can be set to 30% or greater and 90% or less.

From the viewpoint of suppressing occurrence of white spots and improving the on-surface uniformity, the number average particle diameter of the primary particles of the composite particles can be set to 0.03 μm or greater and 0.30 μm or less. When the number average particle diameter of the primary particles of the composite particles is in the above-described range, since stress on the toner is suppressed, the composite particles can be suppressed from being embedded in the surface of the toner. Further, the transfer of the composite particles to the surface of the magnetic carriers can be suppressed, and thus satisfactory on-surface uniformity can be obtained.

From the viewpoint of suppressing occurrence of white spots and improving the on-surface uniformity, in DD-MAS measurement of solid-state ²⁹Si-NMR of the fine particle A, in a case where the proportion of silicon atoms present in a state of the following unit (a) in all silicon atoms is defined as Xa (%), the proportion of silicon atoms present in a state of the following unit (b) in all silicon atoms is defined as Xb (%), and the proportion of silicon atoms present in a state of the following unit (c) is defined as Xc (%), the content proportions of Xa, Xb, and Xc can satisfy Expressions (1) and (2).

$$Xa + Xb + Xc \geq 80 \% \qquad ( 1 )$$

$$Xb + Xc \geq 30 \% \qquad ( 2 )$$

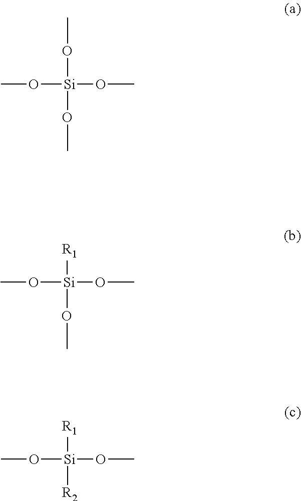

(In Formulae (b) and (c), R₁ and R₂ each independently represent an alkyl group having 1 or more and 6 or less carbon atoms.)

When the content proportions are in the above-described ranges, since the fine particles A can appropriately have polar portions, image density irregularities in a printed image can be suppressed even in a case of long term use, and thus an image with constantly high on-surface uniformity can be obtained.

From the viewpoint of suppressing occurrence of white spots and improving the on-surface uniformity, the resin coated layer present on the surface of the magnetic carrier core can have at least one structure selected from the group consisting of a structure represented by Formula (A), a structure represented by Formula (B), and a structure represented by Formula (C). The present disclosure also includes a case where the resin coated layer has a plurality of these structures.

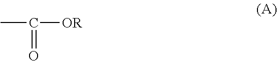

(In Formula (A), R represents an alkyl group having 1 or more and 10 or less carbon atoms.)

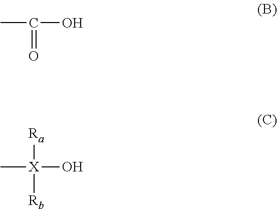

(In Formula (C), X represents a carbon atom or a silicon atom, and Rₐ and R_{b} each independently represent a hydrogen atom or an alkyl group having 1 or more and 10 or less carbon atoms.)

In a case where the resin coated layer does not have the above-described structures, since the interaction between the polar portions of the composite particles transferred to the surface of the magnetic carriers and the polar portions of the resin coated layer of the surface of the magnetic carrier core is weakened, the electric charge concentrated on the protrusions of the composite particles is difficult to diffuse into the resin coated layer, and thus the on-surface uniformity is likely to be decreased. From the viewpoint of further suppressing occurrence of white spots and further improving the on-surface uniformity, the resin coated layer can have a structure represented by Formula (A).

Hereinafter, the configuration of the present disclosure and suitable aspects thereof will be described in detail.

### Composite Particles

The composite particles include fine particles A (i) that use, as a binder component, an organic silicon compound having a siloxane bond, and fine particles B (ii) that are present in a state of being partially embedded in the surface of the fine particles A.

From the viewpoint of suppressing occurrence of white spots and improving the on-surface uniformity, the number average particle diameter of the primary particles of the composite particles can be set to 0.06 μm or greater and 0.30 μm or less.

The number average particle diameter of the primary particles of the composite particles can be further increased by lowering the reaction temperature, shortening the reaction time, or increasing the amount of the catalyst in the hydrolysis and the condensation step. Further, the number average particle diameter of the primary particles of the composite particles can be further decreased by raising the reaction temperature, lengthening the reaction time, or decreasing the amount of the catalyst in the hydrolysis and the condensation step.

From the viewpoint of suppressing occurrence of white spots and improving the on-surface uniformity, “Xb+Xc” in the fine particles A contained in the composite particles can be set to 55% or greater.

Further, from the viewpoint of suppressing occurrence of white spots and improving the on-surface uniformity, the content proportions of the units (a), (b), and (c) satisfy Expressions (12), (13), and (14).

$$30 \% \leq Xa / ( Xa + Xb + Xc ) \leq 80 \% \qquad ( 12 )$$

$$0 \% \leq Xb / ( Xa + Xb + Xc ) \leq 50 \% \qquad ( 13 )$$

$$20 \% \leq Xc / ( Xa + Xb + Xc ) \leq 70 \% \qquad ( 14 )$$

The content proportions of the units (a), (b), and (c) in the composite particles can be controlled by the amount of alkoxysilane having each of the above-described structures to be added.

At least a part of the fine particle is present in a state of being embedded in the surface of the fine particle A, and the average value of the embedment ratios can be set to 30% or greater and 90% or less. The embedment ratio of the fine particles B can be controlled by the reaction time and the reaction temperature between the fine particles B and the alkoxysilane having the above-described structures (a) to (c). In a case where the embedment ratio is intended to be decreased, a method of shortening the reaction time between the alkoxysilane and the fine particles B or a method of decreasing the reaction temperature may be used. In a case where the embedment ratio is intended to be increased, a method of lengthening the reaction time between the alkoxysilane and the fine particles B or a method of increasing the reaction temperature may be used.

In a case where fine particles containing, as a binder component, an organic silicon compound that has a simple siloxane bond without protrusions derived from the fine particles B are used in the toner as an external additive, since the effect of suppressing deterioration of the toner in the two-component developer described above cannot be obtained, adverse effects in an image, such as white spots, cannot be suppressed. Further, in a case where the fine particles B are not completely embedded inside the fine particles A, adverse effects in an image, such as white spots, cannot be suppressed due to the same reason as described above.

Further, methods of measuring various physical property values will be described below.

### Production Method

A method of producing the composite particles is not particularly limited, but the particles can be formed by performing hydrolysis of a silicon compound (silane monomer) using a sol-gel method and a polycondensation reaction. Specifically, the composite fine particles can be formed by performing hydrolysis and polycondensing a mixture of bifunctional silane having two siloxane bonds and tetrafunctional silane having four siloxane bonds and reacting the mixture with colloidal silica. Silane monomers, such as bifunctional silane and tetrafunctional silane, will be described below. The proportion of bifunctional silane is preferably 20% by mole or greater and 70% by mole or less and more preferably 30% by mole or greater and 60% by mole or less. The proportion of trifunctional silane is preferably 0% by mole or greater and 50% by mole or less and more preferably 0% by mole or greater and 40% by mole or less. The proportion of the tetrafunctional silane is preferably 30% by mole or greater and 80% by mole or less and more preferably 40% by mole or greater and 70% by mole or less.

A method of producing the organic silicon compound constituting the fine particles A is not particularly limited, and the organic silicone compound can be obtained, for example, by adding a silane compound dropwise to water, performing hydrolysis using a catalyst and a condensation reaction, and filtering and drying the obtained suspension. The particle diameter can be controlled by the type of catalyst, the compounding ratio, the reaction start temperature, the time for dropwise addition, and the like. Examples of the catalyst include acidic catalysts such as hydrochloric acid, hydrofluoric acid, sulfuric acid, and nitric acid, and basic catalysts such as ammonia water, sodium hydroxide, and potassium hydroxide, but the present disclosure is not limited thereto.

A silicone compound can be produced by the following method. Specifically, the method can include a first step of obtaining a hydrolyzate of a silicon compound, a second step of mixing the hydrolyzate, an alkaline aqueous medium, and colloidal silica, carrying out a polycondensation reaction on the hydrolyzate, and reacting the hydrolyzate with colloidal silica, and a third step of mixing the polycondensation reaction product with an aqueous solution to form particles. In some cases, a hydrophobizing agent may be blended into the mixture.

The first step is performed such that the silicon compound and the catalyst are brought into contact with each other by being stirred, mixed, and the like in an aqueous solution obtained by dissolving an acidic or alkaline substance serving as a catalyst in water. A known catalyst can be suitably used as the catalyst. Specific examples of the catalyst include acidic catalysts such as acetic acid, hydrochloric acid, hydrofluoric acid, sulfuric acid, and nitric acid, and basic catalysts such as ammonia water, sodium hydroxide, and potassium hydroxide.

The amount of the catalyst to be used may be appropriately adjusted by the types of the silicon compound and the catalyst. The amount thereof can be set to 1×10⁻³ parts by mass or greater and 1 part by mass or less with respect to 100 parts by mass of the amount of water used in a case of hydrolyzing the silicon compound.

In a case where the amount of the catalyst to be used is 1×10⁻³ parts by mass or greater, the reaction sufficiently proceeds. Meanwhile, in a case where the amount of the catalyst to be used is 1 part by mass or less, the concentration of the catalyst remaining as an impurity in the fine particles is decreased, and thus the silicon compound is likely to be hydrolyzed. The amount of water to be used can be set to 2 moles or greater and 15 moles or less with respect to 1 mole of the silicon compound. The hydrolysis reaction sufficiently proceeds when the amount of water is 2 moles or greater, and the productivity is improved when the amount thereof is 15 moles or less.

The reaction temperature is not particularly limited, and the reaction may be carried out at room temperature or in a heated state, but from the viewpoint of obtaining a hydrolyzate in a short time and suppressing a partial condensation reaction of the generated hydrolyzate, the reaction can be carried out in a state where the temperature is maintained at 10° C. to 60° C. The reaction time is not particularly limited, and may be appropriately selected in consideration of the reactivity of the silicon compound to be used, the composition of the reaction solution obtained by mixing a silicon compound, an acid, and water, and the productivity.

In the method of producing silicon polymer particles, the second step is performed by mixing the raw material solution obtained in the first step with an alkaline aqueous medium to carry out a polycondensation reaction on the particle precursor. In this manner, a polycondensation reaction solution is obtained. Here, the alkaline aqueous medium is a liquid obtained by mixing an alkaline component, water, and as necessary, an organic solvent and the like.

The alkaline component used in the alkaline aqueous medium is a component in which the aqueous solution thereof exhibits basicity, and acts as a neutralizing agent of the catalyst used in the first step and also acts as the catalyst of the polycondensation reaction in the second step. Examples of such an alkaline component include alkali metal hydroxides such as lithium hydroxide, sodium hydroxide, and potassium hydroxide, ammonia, and organic amines such as monomethylamine and dimethylamine.

The amount of the alkaline component to be used is the amount of the alkaline component that neutralizes the acid and effectively acts as the catalyst for the polycondensation reaction. For example, in a case where ammonia is used as the alkaline component, the amount of ammonia is typically set to 0.01 parts by mass or greater and 12.5 parts by mass or less with respect to 100 parts by mass of a mixture of water and an organic solvent.

In the second step, an organic solvent may be further used in addition to the alkaline component and water in order to prepare an alkaline aqueous medium. The organic solvent is not particularly used as long as the organic solvent has a compatibility with water, and an organic solvent that dissolves 10 g or greater of water per 100 g of the organic solvent at room temperature under normal pressure can be suitably used.

Specific examples of the organic solvent include alcohol such as methanol, ethanol, n-propanol, 2-propanol, or butanol, polyhydric alcohol such as ethylene glycol, diethylene glycol, propylene glycol, glycerin, trimethylolpropane, or hexanetriol, ether such as ethylene glycol monoethyl ether, acetone, diethyl ether, tetrahydrofuran, or diacetone alcohol, and an amide compound such as dimethylformamide, dimethylacetamide, or N-methylpyrrolidone.

Among the organic solvents described above, alcohol-based solvents such as methanol, ethanol, 2-propanol, and butanol can be used. Further, from the viewpoints of hydrolysis and the dehydration condensation reaction, the same alcohol as alcohol generated by desorption can be selected as an organic solvent.

The third step is performed by mixing the polycondensation reaction product obtained in the second step with an aqueous solution to form particles. Water (tap water, pure water, or the like) can be suitably used as the aqueous solution, and a component showing compatibility, such as a salt, an acid, an alkali, an organic solvent, a surfactant, or a water-soluble polymer, with water may be further added to water. The temperature of the polycondensation reaction product and the aqueous solution during the mixing is not particularly limited, and can be suitably set to be in a range of 5° C. to 70° C. in consideration of the compositions thereof, the productivity, and the like.

A known method can be used as a method of recovering particles without particular limitation. Examples of the method include a method of scooping floating powder and a filtration method. Among the examples, a filtration method can be used from the viewpoint that the operation is simple. The filtration method is not particularly limited, and a known device may be selected for vacuum filtration, centrifugal filtration, pressure filtration, or the like. Filter paper, a filter, filter cloth, and the like used for the filtration are not particularly limited as long as these are industrially available, and may be appropriately selected according to the device to be used.

The monomer used for synthesizing the fine particles A of the composite particles can be appropriately selected depending on the compatibility between the solvent and the catalyst, the hydrolysis, or the like, and examples of a tetrafunctional silane monomer having the above-described structure (a) include tetramethoxysilane, tetraethoxysilane, and tetraisocyanatosilane. Among these, tetraethoxysilane can be used.

Examples of the trifunctional silane monomer having the above-described structure (b) include methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxydiethoxysilane, methylacetoxymethoxyethoxysilane, methyltrihydroxysilane, methylmethoxydihydroxysilane, methylethoxydihydroxysilane, methyldimethoxyhydroxysilane, methylethoxymethoxyhydroxysilane, methyldiethoxyhydroxysilane, ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, hexyltrihydroxysilane, phenyltrimethoxysilane, phenyltriethoxysilane, phenyltrichlorosilane, phenyltriacetoxysilane, and phenyltrihydroxysilane. Among these, methyltrimethoxysilane can be used.

Examples of the bifunctional silane monomer having the above-described structure (c) include di-tert-butyldichlorosilane, di-tert-butyldimethoxysilane, di-tert-butyldiethoxysilane, dibutyldichlorosilane, dibutyldimethoxysilane, dibutyldiethoxysilane, dichlorodecylmethylsilane, dimethoxydecylmethylsilane, diethoxydecylmethylsilane, dichlorodimethylsilane, dimethoxydimethylsilane, diethoxydimethylsilane, and diethyldimethoxysilane. Among these, dimethyldimethoxysilane can be used.

Inorganic fine particles such as silica fine particles, alumina fine particles, or titanium oxide fine particles can be suitably used as the fine particles B of the composite particles. Among these, silica fine particles or alumina fine particles can be used. In a case where the fine particles B are the above-described fine particles, the fine particles have moderate conductivity and thus can be used from the viewpoint of improving the on-surface uniformity and stabilizing at endurance. Further, silica fine particles can be more suitably used from the viewpoint of the reactivity with the binder component constituting the fine particles A. The silica fine particles used in the present disclosure are particles containing silica (that is, SiO₂) as a main component, and may be particles produced using, as a raw material, a silicon compound such as water glass or alkoxysilane or particles obtained by pulverizing quartz.

Specific examples thereof include silica particles prepared by a sol-gel method, precipitated silica particles prepared by a precipitation method, aqueous colloidal silica particles, fumed silica particles obtained by a gas phase method, and fused silica particles. Among these, aqueous colloidal silica particles can be suitably used from the viewpoints of the reactivity with the above-described binder component and the dispersion stability. The aqueous colloidal silica particles are commercially available or the aqueous colloidal silica particles can be prepared from various starting materials by a known method. The aqueous colloidal silica particles can be prepared from silicic acid derived from an alkali silicate solution having a pH of about 9 to 11, and a silicate anion undergoes polymerization and generates silica particles having a desired average particle diameter in the form of an aqueous dispersion liquid.

The composite particles can be surface-treated with a hydrophobic treatment agent. The hydrophobic treatment agent is not particularly limited, but an organic silicon compound can be used. Examples thereof include an alkylsilazane compound such as hexamethyldisilazane, an alkylalkoxysilane compound such as diethyldiethoxysilane, trimethylmethoxysilane, methyltrimethoxysilane, or butyltrimethoxysilane, a fluoroalkylsilane compound such as trifluoropropyltrimethoxysilane, a chlorosilane compound such as dimethyldichlorosilane or trimethylchlorosilane, a siloxane compound such as octamethylcyclotetrasiloxane, silicone oil, and silicone varnish.

A change in electrostatic adhesive force of the toner after endurance can be suppressed by performing a hydrophobic treatment on the surface of the composite particles.

Among these, the composite fine particles can be surface-treated with at least one compound selected from the group consisting of an alkylsilazane compound, an alkylalkoxysilane compound, a chlorosilane compound, a siloxane compound, and silicone oil. Further, the composite particles can be surface-treated suitably with an alkylsilazane compound from the viewpoint described above.

From the viewpoint of suppressing occurrence of white spots and improving the on-surface uniformity, the content of the composite particles is preferably 0.1 parts by mass or greater and 10.0 parts by mass or less and more preferably 0.2 parts by mass or greater and 8.0 parts by mass or less with respect to 100 parts by mass of the toner particles.

The fixing ratio of the composite particles onto the toner particles can be set to 50% or greater and 90% or less from the viewpoint of suppressing occurrence of white spots and improving the on-surface uniformity. The methods of measuring the above-described physical properties will be described below.

### Magnetic Carrier

### Resin Coated Layer

The magnetic carrier used in the two-component developer of the present disclosure can have a resin coated layer on the surface of the magnetic carrier core. Further, as described above, the resin coated layer can have at least one structure selected from a structure represented by Formula (A), a structure represented by Formula (B), and a structure represented by Formula (C). The present disclosure also includes a case where the resin coated layer has a plurality of the structures (A) to (C).

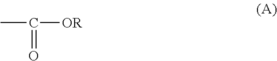

(In Formula (A), R represents an alkyl group having 1 or more and 10 or less carbon atoms.)

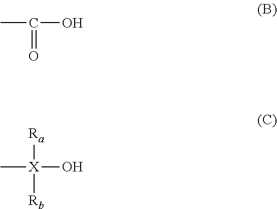

(In Formula (C), X represents a carbon atom or a silicon atom. Rₐ and R_{b} each independently represent a hydrogen atom or an alkyl group having 1 or more and 10 or less carbon atoms.)

The resin coated layer can have the structure represented by Formula (A) from the viewpoint of suppressing occurrence of white spots and improving the on-surface uniformity.

As the resin used in the resin coated layer, a known resin such as a silicone resin or a vinyl resin can be used as long as the resin has any structure represented by Formula (A), (B), or (C). Here, the silicone resin denotes all commonly known silicone resins. Examples of the silicone resin include a straight silicone resin formed of only an organosiloxane bond and a modified silicone resin (modified silicone resin) such as an alkyd, polyester, epoxy, acryl, or urethane. A commercially available product can be used as the silicone resin. Examples of the commercially available product of the straight silicone resin include KR271, KR255, and KR152 (manufactured by Shin-Etsu Chemical Co., Ltd.) and SR2400, SR2406, and SR2410 (manufactured by Dow Corning Toray Silicone Co., Ltd.). In this case, a silicone resin can be used alone, but other components that undergo a crosslinking reaction, components that adjust the charge amount, and the like can also be used together at the same time.

Further, examples of the commercially available product of the modified silicone resin include KR206 (alkyd-modified), KR5208 (acryl-modified), ES1001N (epoxy-modified), and KR305 (urethane-modified) (all manufactured by Shin-Etsu Chemical Co., Ltd.), and SR2115 (epoxy-modified) and SR2110 (alkyd-modified) (both manufactured by Dow Corning Toray Silicone Co., Ltd.).

Further, the vinyl resin is not particularly limited as long as the resin has a structure represented by any of Formulae (A) to (C), but an acrylic resin having a structure represented by Formula (A) can be suitably used from the viewpoint of suppressing occurrence of white spots and improving the on-surface uniformity.

Examples of the monomer constituting an acrylic resin include methyl acrylate, methyl methacrylate, ethyl acrylate, ethyl methacrylate, butyl acrylate (n-butyl, sec-butyl, iso-butyl, or tert-butyl, the same applies hereinafter), butyl methacrylate, 2-ethylhexyl acrylate, 2-ethylhexyl methacrylate, nonyl acrylate, and nonyl methacrylate. Further, the monomer constituting an acrylic resin may be a monomer containing (meth)acrylic acid ester that contains an alicyclic hydrocarbon group, and examples thereof include cyclobutyl acrylate, cyclopentyl acrylate, cyclohexyl acrylate, cycloheptyl acrylate, dicyclopentenyl acrylate, dicyclopentanyl acrylate, cyclobutyl methacrylate, cyclopentyl methacrylate, cyclohexyl methacrylate, cycloheptyl methacrylate, dicyclopentenyl methacrylate, and dicyclopentanyl methacrylate. Further, a macromonomer may be used as the monomer constituting an acrylic resin. Examples of the macromonomer include a macromonomer which is a polymer of at least one monomer selected from the group consisting of methyl acrylate, methyl methacrylate, butyl acrylate, butyl methacrylate, 2-ethylhexyl acrylate, and 2-ethylhexyl methacrylate. One or two or more kinds of the above-described monomers may be selected and used. Among the above-described monomers, a (meth)acrylic acid ester monomer containing an alicyclic hydrocarbon group having 4 or more and 8 or less carbon atoms, a (meth)acrylic acid ester monomer containing an alkyl group having 1 or more and 8 or less carbon atoms, and the above-described macromonomers can be used.

A copolymer obtained by radically polymerizing the above-described monomers can be used as the resin used in the resin coated layer. The monomers used in the copolymer may be used by selecting one or two or more of the above-described monomers. More suitably, the resin coated layer has a structure represented by Formula (A) and is formed of a copolymer of monomers including a (meth)acrylic acid ester monomer containing an alicyclic hydrocarbon group or a (meth)acrylic acid monomer containing an alkyl group having 1 or more and 8 or less carbon atoms.

From the viewpoint of suppressing occurrence of white spots and improving the on-surface uniformity, the concentration of the ester group in the acrylic resin having a structure represented by Formula (A) can be set to 5.0 mmol/g or greater and 11.0 mmol/g or less.

In a case where the value of the middle part in Expression (9) in the above-described composite particles is defined as a, and the concentration of the ester group in the acrylic resin is defined as β (mmol/g), Expression (11) can be satisfied. In addition, the middle part in Expression (9) indicates the following part.

$$\frac{SD 1}{SSi} + \frac{2 \times ST 1}{SSi} + \frac{ST 2}{SSi} + \frac{3 \times SQ 1}{SSi} + \frac{2 \times SQ 2}{SSi} + \frac{SQ 3}{SSi} \qquad ( 11 )$$

$$16. \leq β / α \leq 100.0$$

When β/α is set to be in the above-described range, the interaction between the composite particles and the resin coated layer is further improved, and thus the suppression of the occurrence of white spots and the improvement of the on-surface uniformity can be achieved.

### Magnetic Carrier Core

Next, the magnetic carrier core will be described.

A known magnetic carrier core can be used as the magnetic carrier core. Magnetic material dispersed resin particles in which a magnetic material is dispersed in a resin component or porous magnetic core particles containing a resin in a void portion can be more suitably used.

These particles are capable of decreasing the true density of magnetic carriers, and thus the load on a toner can be reduced. In this manner, deterioration of the image quality is less even in a case of long-term use, and the replacement frequency of a developer formed of a toner and a carrier can be reduced. However, the present disclosure is not limited to the description above, the effects of the present disclosure can be sufficiently exhibited even when commercially available magnetic carrier cores are used.

As the magnetic material component used in the magnetic material dispersed resin particles, various magnetic iron compound particle powders, such as magnetite particle powder, maghemite particle powder, or magnetic iron oxide particle powder containing at least one selected from silicon oxide, silicon hydroxide, aluminum oxide, and aluminum hydroxide; magnetoplumbite-type ferrite particle powder containing barium, strontium, or barium-strontium; and spinel-type ferrite particle powder containing at least one selected from manganese, nickel, zinc, lithium, and magnesium, can be used. Among these, magnetic iron oxide particle powder can be suitably used.

Further, in addition to the magnetic material component, non-magnetic inorganic compound particle powder, such as non-magnetic iron oxide particle powder such as hematite particle powder, non-magnetic ferric hydroxide-containing particle powder such as goethite particle powder, titanium oxide particle powder, silica particle powder, talc particle powder, alumina particle powder, barium sulfate particle powder, barium carbonate particle powder, cadmium yellow particle powder, calcium carbonate particle powder, or zinc oxide particle powder may also be used in combination with the magnetic iron compound particle powder.

In a case where the magnetic iron compound particle powder and the non-magnetic inorganic compound particle powder are used in the form of a mixture, the amount of the magnetic iron compound particle powder can be set to at least 30% by mass in terms of the mixing ratio thereof.

The magnetic iron compound particle powder can be entirely or partially treated with a lipophilic treatment agent. The lipophilic treatment agent used in this case can be an organic compound containing one or two or more functional groups selected from an epoxy group, an amino group, a mercapto group, an organic acid group, an ester group, a ketone group, a halogenated alkyl group, and an aldehyde group, or a mixture thereof. The organic compound containing a functional group can be a coupling agent, suitably a silane coupling agent, a titanium coupling agent, or an aluminum coupling agent, and more suitably a silane coupling agent.

A thermosetting resin can be used as the binder resin constituting the magnetic material dispersed resin particles.

Examples thereof include a phenol resin, an epoxy resin, and an unsaturated polyester resin. Among these, a phenol resin can be suitably used from the viewpoints of low cost and ease of production. Examples of the phenol resin include a phenol-formaldehyde resin.

The content proportions of the binder resin and the magnetic iron compound particle powder (or a mixture of the magnetic iron compound particle powder and the non-magnetic inorganic compound particle powder) can be set to 1% by mass or greater and 20% by mass or less of the binder resin and 80% by mass or greater and 99% by mass or less of the magnetic iron compound particle powder (or the mixture described above).

Next, a method of producing the magnetic material dispersed resin particles will be described.

The composite particles can be produced, for example, by a method of stirring phenols and aldehydes in an aqueous medium in the presence of magnetic and non-magnetic inorganic compound particle powders and a basic catalyst as described in examples below, and reacting and curing the phenols and the aldehydes to generate composite particles containing inorganic compound particles such as magnetic iron oxide particle powder and a phenol resin.

Further, the composite particles can also be produced by a so-called kneading and pulverizing method of pulverizing a binder resin containing inorganic compound particles such as magnetic iron oxide particle powder. The former method can be suitably used from the viewpoint of easily controlling the particle diameter of the magnetic carrier and obtaining a sharp particle size distribution.

Next, the porous magnetic core particles will be described.

Magnetite or a ferrite can be used as the material of the porous magnetic core particles. Further, a ferrite can be suitably used as the material of the porous magnetic core particles from the viewpoint of controlling the porous structure of the porous magnetic core particles and adjusting the resistance.

The ferrite is a sintered material represented by the following general formula.

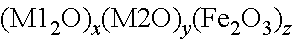

(In the formula, M1 represents a monovalent metal, M2 represents a divalent metal, x and y each satisfy 0≤(x, y)≤0.8 in a case of x+y+z=1.0, and z satisfies 0.2<z<1.0.)

In the formula, at least one metal selected from the group consisting of Li, Fe, Mn, Mg, Sr, Cu, Zn, and Ca can be used as M1 and M2. In addition to these atoms, Ni, Co, Ba, Y, V, Bi, In, Ta, Zr, B, Mo, Na, Sn, Ti, Cr, Al, Si, rare earth metals, and the like can also be used.

The magnetic carrier can be used from the viewpoint of controlling the state of unevenness on the surface of the porous magnetic core particles so that the amount of magnetization is moderately maintained and the pore diameter is set to be in a desired range. Further, the magnetic carrier can also be suitably used from the viewpoint of easily controlling the speed of the ferritization reaction and suitably controlling the specific resistance and the magnetic force of the porous magnetic core. From the above-described viewpoints, a Mn-based ferrite, a Mn—Mg-based ferrite, a Mn—Mg—Sr-based ferrite, or a Li—Mn-based ferrite, which contains a Mn element, can be more suitably used.

Hereinafter, the production steps in a case where porous ferrite particles are used as the magnetic carrier core will be described in detail.

### Step 1 (Weighing and Mixing Step)

Raw materials of the ferrite are weighed and mixed.

Examples of the ferrite raw materials include metal particles of the metal elements, and an oxide, a hydroxide, an oxalate, a carbonate, and the like of the metal elements.

Examples of a mixing device include a ball mill, a planetary mill, a Giotto mill, and a vibration mill. Among these, a ball mill can be suitably used from the viewpoint of mixing properties. Specifically, the weighed ferrite raw materials and balls can be placed in a ball mill and pulverized and mixed for 0.1 hours or longer and 20.0 hours or shorter.

### Step 2 (Pre-Calcination Step)

The pulverized and mixed ferrite raw materials can be pre-calcined at a calcination temperature of 700° C. or higher and 1200° C. or lower for 0.5 hours or longer and 5.0 hours or shorter in an atmospheric or nitrogen atmosphere for ferritization. Examples of a furnace that can be used for the calcination include a burner-type incinerator, a rotary calcination furnace, and an electric furnace.

### Step 3 (Pulverization Step)

The pre-calcined ferrite prepared in the step 2 is pulverized by a pulverizer. The pulverizer is not particularly limited as long as a desired particle diameter can be obtained. Examples of the pulverizer include a crusher, a hammer mill, a ball mill, a bead mill, a planetary mill, and a Giotto mill.

A ferrite pulverized product can be set to have a desired particle diameter by controlling, for example, the materials of balls and beads used in a ball mill and a bead mill, the particle diameter, and the operation time. Specifically, the particle diameter of a pre-calcined ferrite slurry may be decreased by using balls with a high specific gravity or increasing the pulverization time. Further, the particle diameter distribution of the pre-calcined ferrite can be widened by using balls or beads with a high specific gravity and reducing the pulverization time. Further, a pre-calcined ferrite with a wide distribution can be obtained by mixing a plurality of pre-calcined ferrites with different particle diameters.

Further, wet ball mills and wet bead mills can be suitably used than dry ball mills and dry bead mills from the viewpoint that pulverized products do not fly up in the mills and the pulverization efficiency is high. Therefore, wet ball mills and wet bead mills can be suitably used than dry ball mills and dry bead mills.

Step 4 (granulation Step)

Water, a binder, and as necessary, a pore adjuster are added to the pulverized product of pre-calcined ferrite. Examples of the pore adjuster include a foaming agent and resin fine particles.

Examples of the foaming agent include sodium hydrogen carbonate, potassium hydrogen carbonate, lithium hydrogen carbonate, ammonium hydrogen carbonate, sodium carbonate, potassium carbonate, lithium carbonate, and ammonium carbonate.

Examples of the resin fine particles include fine particles of polyester, polystyrene, a styrene copolymer such as a styrene-vinyltoluene copolymer, a styrene-vinylnaphthalene copolymer, a styrene-acrylic acid ester copolymer, a styrene-methacrylic acid ester copolymer, a styrene-α-methyl chloromethacrylate copolymer, a styrene-acrylonitrile copolymer, a styrene-vinyl methyl ketone copolymer, a styrene-butadiene copolymer, a styrene-isoprene copolymer, or a styrene-acrylonitrile-indene copolymer; polyvinyl chloride, a phenolic resin, a modified phenolic resin, a maleic resin, an acrylic resin, a methacrylic resin, polyvinyl acetate, a silicone resin; a polyester resin containing, as a structural unit, a monomer selected from an aliphatic polyhydric alcohol, an aliphatic dicarboxylic acid, an aromatic dicarboxylic acid, aromatic dialcohols, and diphenols; a polyurethane resin, a polyamide resin, polyvinyl butyral, a terpene resin, a coumarone-indene resin, a petroleum resin, and a hybrid resin having a polyester unit and a vinyl-based polymer unit.

For example, polyvinyl alcohol can be used as the binder.

In the step 3, a binder and as necessary, a pore adjuster can also be added to the pulverized product in consideration of water contained in the ferrite slurry in a case of wet type pulverization.

The obtained ferrite slurry can be dried and granulated in a heated atmosphere of 100° C. or higher and 200° C. or lower using a spray drying machine. The spray drying machine is not particularly limited as long as a desired particle diameter of the porous magnetic core particles can be obtained. For example, a spray dryer can be used.

### Step 5 (Main Calcination Step)

Next, the granulated product can be calcined at 800° C. or higher and 1400° C. or lower for 1 hour or longer and 24 hours or shorter.

The calcination of the porous magnetic core particles progresses when the calcination temperature and the calcination time are increased, and as a result, the pore diameter is decreased, and the number of pores is reduced.

### Step 6 (Sorting Step)

The particles calcined as described above are crushed, and may be classified or sieved with a sieve as necessary to remove coarse particles or fine particles.

The 50% particle diameter (D50) of the magnetic core particles based on volume distribution can be set to 18.0 μm or greater and 68.0 μm or less.

### Step 7 (Filling Step)

The physical strength of the porous magnetic core particles is decreased depending on the internal pore volume in some cases, and thus some voids of the porous magnetic core particles can be filled with a resin in order to increase the physical strength as the magnetic carriers. The amount of the resin filling the porous magnetic core particles can be set to 2% by mass or greater and 15% by mass or less in the porous magnetic core particles.

In a case where the variation in the resin content of each magnetic carrier is low, only some internal voids may be filled with a resin, only voids in the vicinity of the surface of the porous magnetic core particles may be filled with a resin with voids remaining inside, or the internal voids may be completely filled with a resin.

A method of filling the voids of the porous magnetic core particles with a resin is not particularly limited, and examples thereof include a method of impregnating the porous magnetic core particles with a resin solution using a coating method such as a dipping method, a spraying method, a brush coating method, or a fluidized bed method and volatilizing the solvent. Further, a method of diluting a resin with a solvent and adding the resin to the voids of the porous magnetic core particles can also be employed.

The solvent used here may be any solvent that can dissolve a resin. In a case of a resin that is soluble in an organic solvent, examples of the organic solvent include toluene, xylene, cellosolve butyl acetate, methyl ethyl ketone, methyl isobutyl ketone, and methanol. Further, in a case of a water-soluble resin or an emulsion-type resin, water may be used as the solvent.

The amount of the resin solid content in the resin solution is preferably 1% by mass or greater and 50% by mass or less and more preferably 1% by mass or greater and 30% by mass or less. In a case where the amount thereof is 50% by mass or less, the viscosity is not extremely high, and the resin solution is likely to uniformly penetrate into the voids of the porous magnetic core particles. Meanwhile, in a case where the amount thereof is 1% by mass or greater, the amount of the resin is appropriate, and the adhesive force of the resin to the porous magnetic core particles is enhanced.

Any of a thermoplastic resin or a thermosetting resin may be used as the resin filling the voids of the porous magnetic core particles. A resin having a high affinity for the porous magnetic core particles can be used. In a case where a resin with a high affinity for the porous magnetic core particles is used, the surface of the porous magnetic core particles can also be covered with the resin at the same time as the voids of the porous magnetic core particles are filled with the resin.

Examples of the thermoplastic resin that can be used as the resin filling the voids include a novolac resin, a saturated alkyl polyester resin, polyarylate, a polyamide resin, and an acrylic resin.

Further, examples of the thermosetting resin include a phenolic resin, an epoxy resin, an unsaturated polyester resin, and a silicone resin.

A method of covering the surface of the magnetic carrier core particles with the resin is not particularly limited, and examples thereof include a method of covering the surface using a coating method such as a dipping method, a spraying method, a brush coating method, a dry method, or a fluidized bed coating method.

From the viewpoint of suppressing occurrence of white spots and improving the on-surface uniformity, the content of the resin coated layer of the magnetic carrier can be set to 0.5 parts by mass or greater and 3.5 parts by mass or less with respect to 100 parts by mass of the magnetic carrier core particles.

Further, the resin coated layer may contain particles having conductivity or particles and materials having electric charge controllability. Examples of the particles having conductivity include carbon black, magnetite, graphite, zinc oxide, and tin oxide.

The amount of the particles having conductivity to be added can be set to 0.1 parts by mass or greater and 10.0 parts by mass or less with respect to 100 parts by mass of the coated resin from the viewpoint of adjusting the resistance of the magnetic carriers.

Examples of the particles having electric charge controllability include organic metal complex particles, organic metal salt particles, chelate compound particles, monoazo metal complex particles, acetal acetone metal complex particles, hydroxycarboxylic acid metal complex particles polycarboxylic acid metal complex particles, polyol metal complex particles, polymethyl methacrylate resin particles, polystyrene resin particles, melamine resin particles, phenolic resin particles, nylon resin particles, silica particles, titanium oxide particles, and alumina particles.

From the viewpoint of adjusting the triboelectric charge amount, the amount of the particles having the electric charge controllability to be added can be set to 0.5 parts by mass or greater and 50.0 parts by mass or less with respect to 100 parts by mass of the coated resin.

### Toner Particles and Toner

### Constituent Material of Toner Particles

### Binder Resin

The toner particles contain a binder resin, and a known binder resin can be used in the toner particles. Examples of the binder resin include a styrene-based resin, a styrene-based copolymer resin, a polyester resin, a polyol resin, a polyvinyl chloride resin, a phenolic resin, a natural resin-modified phenolic resin, a natural resin-modified maleic acid resin, an acrylic resin, a methacrylic resin, polyvinyl acetate, a silicone resin, a polyurethane resin, a polyamide resin, a furan resin, an epoxy resin, a xylene resin, polyvinyl butyral, a terpene resin, a coumarone-indene resin, and a petroleum-based resin. Here, a styrene-based copolymer resin, a polyester resin, and a hybrid resin obtained by mixing or partially reacting a polyester resin with a styrene-based copolymer resin can be used. Among these, a polyester resin can be suitably used.

Components constituting the polyester resin will be described in detail. Further, the following various components can be used alone or in combination of two or more kinds thereof depending on the type and the applications thereof.

Examples of a divalent carboxylic acid component constituting a polyester resin include benzenedicarboxylic acids such as phthalic acid, terephthalic acid, isophthalic acid, and phthalic anhydride, anhydrides thereof, or lower alkyl esters thereof; alkyl dicarboxylic acids such as succinic acid, adipic acid, sebacic acid, and azelaic acid, anhydrides thereof, or lower alkyl esters thereof; alkenylsuccinic acids or alkylsuccinic acids with an average carbon number of 1 or more and 50 or less, anhydrides thereof, or lower alkyl esters thereof; and unsaturated dicarboxylic acids such as fumaric acid, maleic acid, citraconic acid, and itaconic acid, anhydrides thereof, or lower alkyl esters thereof.

Examples of the alkyl group in the lower alkyl esters include a methyl group, an ethyl group, a propyl group, and an isopropyl group.

Meanwhile, examples of a dihydric alcohol component constituting the polyester resin include ethylene glycol, polyethylene glycol, 1,2-propanediol, 1,3-propanediol, 1,3-butanediol, 1,4-butanediol, 2,3-butanediol, diethylene glycol, triethylene glycol, 1,5-pentanediol, 1,6-hexanediol, neopentyl glycol, 2-methyl-1,3-propanediol, 2-ethyl-1,3-hexanediol, 1,4-cyclohexanedimethanol (CHDM), hydrogenated bisphenol A, biphenol represented by Formula (I-1) and derivatives thereof, and diols represented by Formula (I-2).

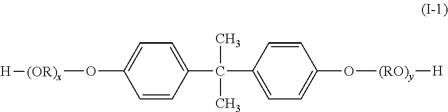

(In Formula (I-1), R represents an ethylene group or a propylene group, x and y each independently represent an integer of 0 or greater, and an average value of x+y is 0 or greater and 10 or less.)

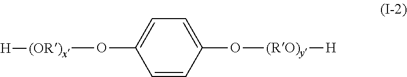

(In Formula (I-2), R′ represents an ethylene group or a propylene group, x′ and y′ each independently represent an integer of 0 or greater, and an average value of x′+y′ is 0 or greater and 10 or less.)

The constituent components of the polyester resin may include a tri- or higher valent carboxylic acid component and a tri- or higher hydric alcohol component in addition to the divalent carboxylic acid component and the dihydric alcohol component described above.

The tri- or higher valent carboxylic acid component is not particularly limited, and examples thereof include trimellitic acid, trimellitic anhydride, and pyromellitic acid. Further, examples of the tri- or higher hydric alcohol component include trimethylolpropane, pentaerythritol, and glycerin.

The constituent components of the polyester resin include a monovalent carboxylic acid component and a monohydric alcohol component as the constituent components in addition to the above-described compounds. Specific examples of the monovalent carboxylic acid component include palmitic acid, stearic acid, arachidic acid, behenic acid, cerotic acid, heptacosanoic acid, montanoic acid, melissic acid, lacceric acid, tetracontanoic acid, and pentacontanoic acid.

Further, examples of the monohydric alcohol component include behenyl alcohol, ceryl alcohol, melissyl alcohol, and tetracontanol.

### Colorant

As a black pigment, carbon black such as furnace black, channel black, acetylene black, thermal black, or lamp black is used. Further, magnetic powder such as magnetite or ferrite is also used.

A pigment or a dye can be used as a suitable colorant for a yellow color. Examples of the pigment include C.I. Pigment Yellow 1, 2, 3, 4, 5, 6, 7, 10, 11, 12, 13, 14, 15, 17, 23, 62, 65, 73, 74, 81, 83, 93, 94, 95, 97, 98, 109, 110, 111, 117, 120, 127, 128, 129, 137, 138, 139, 147, 151, 154, 155, 167, 168, 173, 174, 176, 180, 181, 183, and 191, and C.I. Vat Yellow 1, 3, and 20. Examples of the dye include C.I. Solvent Yellow 19, 44, 77, 79, 81, 82, 93, 98, 103, 104, 112, and 162. These pigments and dyes are used alone or in combination of two or more kinds thereof.

A pigment or a dye can be used as a suitable colorant for a cyan color. Examples of the pigment include C.I. Pigment Blue 1, 7, 15, 15:1, 15:2, 15:3, 15:4, 16, 17, 60, 62, and 66, C.I. Vat Blue 6, and C.I. Acid Blue 45. Examples of the dye include C.I. Solvent Blue 25, 36, 60, 70, 93, and 95. These pigments and dyes are used alone or in combination of two or more kinds thereof.

A pigment or a dye can be used as a suitable colorant for a magenta color. Examples of the pigment include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:2, 48:3, 48:4, 49, 50, 51, 52, 53, 54, 55, 57, 57:1, 58, 60, 63, 64, 68, 81, 81:1, 83, 87, 88, 89, 90, 112, 114, 122, 123, 144, 146, 150, 163, 166, 169, 177, 184, 185, 202, 206, 207, 209, 220, 221, 238, and 254, C.I. Pigment Violet 19, and C.I. Vat Red 1, 2, 10, 13, 15, 23, 29, and 35.

Examples of the dye for magenta include oil-soluble dyes such as C.I. Solvent Red 1, 3, 8, 23, 24, 25, 27, 30, 49, 52, 58, 63, 81, 82, 83, 84, 100, 109, 111, 121, and 122, C.I. Disperse Red 9, C.I. Solvent Violet 8, 13, 14, 21, and 27, and C.I. Disperse Violet 1; and basic dyes such as C.I. Basic Red 1, 2, 9, 12, 13, 14, 15, 17, 18, 22, 23, 24, 27, 29, 32, 34, 35, 36, 37, 38, 39, and 40, and C.I. Basic Violet 1, 3, 7, 10, 14, 15, 21, 25, 26, 27, and 28. These pigments and dyes are used alone or in combination of two or more kinds thereof.

The content of the colorant can be set to 1 part by mass or greater and 20 parts by mass or less with respect to 100 parts by mass of the binder resin.

### Release Agent

A release agent (wax) may be used to impart releasability to the toner.

Examples of the wax include aliphatic hydrocarbon-based wax such as low-molecular-weight polyethylene, low-molecular-weight polypropylene, an olefin copolymer, microcrystalline wax, paraffin wax, or Fischer-Tropsch wax; oxidized wax of aliphatic hydrocarbon-based wax, such as oxidized polyethylene wax; waxes containing, as a main component, fatty acid ester, such as carnauba wax, behenyl behenate, and montanic acid ester wax; and wax obtained by partially or entirely deoxidizing fatty acid ester, such as deoxidized carnauba wax.

Further, other examples thereof include saturated straight-chain fatty acids such as palmitic acid, stearic acid, and montanic acid; unsaturated fatty acids such as brassidic acid, eleostearic acid, and valinaric acid; saturated alcohols such as stearyl alcohol, aralkyl alcohol, behenyl alcohol, carnaubyl alcohol, ceryl alcohol, and melissyl alcohol; polyhydric alcohols such as sorbitol; fatty acid amides such as linoleic amide, oleic acid amide, and lauric acid amide; saturated fatty acid bisamides such as methylene bisstearic acid amide, ethylene biscapric acid amide, ethylene bislauric acid amide, and hexamethylene bisstearic acid amide; unsaturated fatty acid amides such as ethylene bisoleic acid amide, hexamethylene bisoleic acid amide, N,N′-dioleyl adipic acid amide, and N,N-dioleyl sebacic acid amide; aromatic bisamides such as m-xylene bisstearic acid amide and N,N′-distearyl isophthalic acid amide; fatty acid metal salts (commonly known as metallic soaps) such as calcium stearate, calcium laurate, zinc stearate, and magnesium stearate; waxes obtained by grafting aliphatic hydrocarbon-based wax with a vinyl-based copolymer monomer such as styrene or acrylic acid; partially esterified materials of fatty acids and polyhydric alcohols, such as behenic acid monoglyceride; and methyl ester compounds containing a hydroxy group obtained by hydrogenation of vegetable fats and oils.

Among these, aliphatic hydrocarbon-based wax can be suitably used. For example, a low-molecular-weight hydrocarbon obtained by radically polymerizing alkylene under high pressure or polymerizing alkylene with a Ziegler catalyst or a metallocene catalyst under low pressure; Fischer-Tropsch wax synthesized from coal or natural gas; paraffin wax; an olefin polymer obtained by pyrolyzing a high-molecular-weight olefin polymer; synthetic hydrocarbon wax obtained from distillation residues of hydrocarbons obtained from a synthetic gas containing carbon monoxide and hydrogen by an ARRGE process; and synthetic hydrocarbon wax obtained by hydrogenating these waxes can be suitably used.

Further, waxes obtained by fractionation of hydrocarbon wax using a press sweating method, a solvent method, vacuum distillation, or a fractional crystallization method can be more suitably used. Among paraffin waxes, n-paraffin wax and Fischer-Tropsch wax, which mainly contain a straight-chain component, are particularly suitable from the viewpoint of molecular weight distribution.

These waxes may be used alone or in combination of two or more kinds thereof. The amount of wax to be added can be set to 1 part by mass or greater and 20 parts by mass or less with respect to 100 parts by mass of the binder resin.

### Charge Control Agent

A charge control agent may be used in the toner. A known charge control agent can be used as the charge control agent. Examples thereof include an azo-based iron compound, an azo-based chromium compound, an azo-based manganese compound, an azo-based cobalt compound, an azo-based zirconium compound, a chromium compound of a carboxylic acid derivative, a zinc compound of a carboxylic acid derivative, an aluminum compound of a carboxylic acid derivative, and a zirconium compound of a carboxylic acid derivative. An aromatic hydroxycarboxylic acid can be used as the carboxylic acid derivative. Further, a charge control resin can also be used. As necessary, one or two or more kinds of charge control agents may be used in combination. The amount of the charge control agent to be used can be set to 0.1 parts by mass or greater and 10 parts by mass or less with respect to 100 parts by mass of the binder resin.

### Inorganic Fine Powder

In addition to the composite particles, a plurality of other inorganic fine powders can also be used in combination as necessary. The inorganic fine powder may be internally added to the toner particles or may be mixed with the toner base particles as an external additive. Inorganic fine powder such as silica can be used as the external additive. The inorganic fine powder can be hydrophobized with a hydrophobizing agent such as a silane compound, silicone oil, or a mixture thereof.

Inorganic fine powder having a specific surface area of 50 m²/g or greater and 400 m²/g or less can be used as the external additive for improving the flowability. Inorganic fine particles in which the specific surface area is in the above-described range may be used in combination in order to achieve both improvement of the flowability and stabilization at endurance.

The amount of the inorganic fine powder to be used can be set to 0.1 parts by mass or greater and 10.0 parts by mass or less with respect to 100 parts by mass of the toner particles. In a case where the amount thereof is in the above-described range, the effect of stabilizing at endurance is likely to be obtained.

### Method of Producing Toner Particles

In the steps of obtaining the toner particles, the method of producing the toner particles is not particularly limited, and the toner particles can be produced by a known method. Examples thereof include a pulverization method, an emulsion aggregation method, a suspension polymerization method, and a dissolution suspension method.

### Pulverization Method

The toner particles to be produced by the pulverization method are produced, for example, in the following manner.

The binder resin, the colorant, and as necessary, other additives and the like are sufficiently mixed in a mixer such as a Henschel mixer or a ball mill. The mixture is melt-kneaded using a thermal kneader such as a twin-screw kneading extruder, a heating roll, a kneader, or an extruder. In this case, wax, magnetic iron oxide particles, and metal-containing compounds can also be added thereto.

The melt-kneaded material is cooled, solidified, pulverized, and classified to obtain toner particles. Here, the embedment ratio of the silica fine particles in the surface of the toner particles can be controlled by adjusting the exhaust gas temperature during fine pulverization. The toner can be obtained by mixing the toner particles with the external additive such as silica fine particles in a mixer such as a Henschel mixer.

Examples of the mixer include a Henschel mixer (manufactured by MITSUI MINING & SMELTING CO., LTD.), Super Mixer (manufactured by KAWATA MFG. CO., LTD.), RIBOCONE (manufactured by OKAWARA MFG. CO., LTD.), NAUTA MIXER, TURBULIZER, and Cyclomix (all manufactured by Hosokawa Micron Corporation), Spiral Pin Mixer (manufactured by Pacific Machinery & Engineering Co., Ltd.), and Loedige Mixer (manufactured by MATSUBO Corporation).

Examples of the kneader include KRC Kneader (manufactured by KURIMOTO, LTD.), Buss Co-kneader (manufactured by Buss AG), TEM type Extruder (manufactured by SHIBAURA MACHINE CO., LTD.), TEX Twin-Screw Kneader (manufactured by THE JAPAN STEEL WORKS, LTD.), PCM Kneader (manufactured by Ikegai Corp.), a three-roll mill, a mixing roll mill, and a kneader (all manufactured by INQUE MFG., INC.), KNEADEX (manufactured by MITSUI MINING & SMELTING CO., LTD.), an MS type pressure kneader, KNEADER-RUDER (manufactured by Moriyama Manufacturing Co., Ltd.), and a Banbury mixer (manufactured by Kobe Steel, Ltd.).

Examples of the pulverizer include Counter Jet mill, Micron Jet, and INOMIZER (all manufactured by Hosokawa Micron Corporation), an IDS type mill and a PJM jet pulverizer (both manufactured by Nippon Pneumatic Mgf. Co., Ltd.), Cross Jet Mill (manufactured by Kurimoto, Ltd.), ULMAX (manufactured by MISSO ENGINEERING CO., LTD.), SK Jet O Mill (manufactured by SEISHIN ENTERPRISE CO., LTD.), KRYPTRON (manufactured by Kawasaki Heavy Industries, Ltd.), Turbo Mill (manufactured by FREUND-TURBO CORPORATION), and Super Rotor (manufactured by Nisshin Engineering Inc.).

Further, the embedment ratio of the silica fine particles in the surface of the toner particles can be controlled by performing a surface treatment on the toner particles using Hybridization System (manufactured by Nara Machinery Co., Ltd.), NOBILTA (manufactured by Hosokawa Micron Corporation), Mechanofusion System (manufactured by Hosokawa Micron Corporation), FACULTY (manufactured by Hosokawa Micron Corporation), INOMIZER (manufactured by Hosokawa Micron Corporation), Theta Composer (manufactured by TOKUJU CORPORATION), Mechano Mill (manufactured by OKADA SEIKO CO., LTD.), or METERORAINBOW MR Type (manufactured by Nippon Pneumatic Mfg. Co., Ltd.) after the pulverization as necessary.

Examples of the classifier include Classeal, Micron Clssifier, and Spedic Classifier (all manufactured by SEISHIN ENTERPRISE CO., LTD.), Turbo Classifier (manufactured by Nisshin Engineering Inc.), Micron Separator, Turboplex (ATP), and TSP Separator (all manufactured by Hosokawa Micron Corporation), Elbow Jet (manufactured by Nittetsu Mining Co., Ltd.), Dispersion Separator (manufactured by Nippon Pneumatic Mgf. Co., Ltd.), and YM Microcut (manufactured by Yasukawa Corporation).

Examples of a sieving device used to sift coarse particles include Ultrasonic (manufactured by KOUEI-SANGYOU CO., LTD.), Resonasieve and Gyro-sifter (both manufactured by TOKUJU CORPORATION), Vibrasonic System (manufactured by Dalton Corporation), Soniclean (manufactured by SHINTOKOGIO, LTD.), TURBO SCREENER (manufactured by manufactured by FREUND-TURBO CORPORATION), MICRO SIFTER (manufactured by MAKINO MFG. CO., LTD.), and a circular vibration sieve.

### Emulsion Aggregation Method

The toner particles are produced by the emulsion aggregation method, for example, in the following manner.

### Step of Preparing Resin Fine Particle Dispersion Liquid (Preparation Step)

For example, a polyester resin and a styrene-acrylic resin are dissolved in an organic solvent as binder resin components to form a uniformly dissolved solution. Thereafter, a basic compound and a surfactant are added thereto as necessary. An aqueous medium is slowly added to this dissolved solution while a shear force is applied thereto using a homogenizer or the like to form resin fine particles of the binder resin. Finally, the organic solvent is removed, thereby preparing a resin fine particle dispersion liquid in which the resin fine particles are dispersed.

In the preparation of the resin fine particle dispersion liquid, the addition amount of the resin components dissolved in the organic solvent is preferably 10 parts by mass or greater and 50 parts by mass or less and more preferably 30 parts by mass or greater and 50 parts by mass or less with respect to 100 parts by mass of the organic solvent.

Any organic solvent can be used as the organic solvent as long as the organic solvent can dissolve resin components, but a solvent having a high solubility with respect to olefin-based resins such as toluene, xylene, and ethyl acetate can be used.

The surfactant is not particularly limited. Examples thereof include an anionic surfactant such as a sulfuric acid ester salt-based surfactant, a sulfonate-based surfactant, a carboxylate-based surfactant, a phosphoric acid ester-based surfactant, or a soap-based surfactant, a cationic surfactant such as an amine salt type surfactant or a quaternary ammonium salt type surfactant, and a non-ionic surfactant such as a polyethylene glycol-based surfactant, an alkylphenol ethylene oxide adduct-based surfactant, or a polyhydric alcohol-based surfactant.

Examples of the basic compound include an inorganic base such as sodium hydroxide or potassium hydroxide, and an organic base such as triethylamine, trimethylamine, dimethylaminoethanol, or diethylaminoethanol. The basic compound may be used alone or in combination of two or more kinds thereof.

### Aggregation Step

The aggregation step is, for example, a step of mixing a colorant fine particle dispersion liquid, a wax fine particle dispersion liquid, and a silicone oil emulsified liquid as necessary with the resin fine particle dispersion liquid to prepare a mixed solution and aggregating the fine particles contained in the prepared mixed solution to form aggregate particles.

As a method of forming the aggregate particles, a method of adding an aggregating agent and mixing the aggregating agent into the mixed solution, increasing the temperature, or applying mechanical power as appropriate can be suitably used.

The colorant fine particle dispersion liquid is prepared by dispersing the above-described colorant. The colorant fine particles are dispersed by a known method, and for example, a media type dispersing machine such as a rotary shear type homogenizer, a ball mill, a sand mill, or an attritor, and a high pressure counter collision type dispersion machine can be suitably used. Further, a surfactant or a polymer dispersing agent, which imparts dispersion stability, can be added to the dispersion liquid as necessary.

The wax fine particle dispersion liquid and the silicone oil emulsified liquid are prepared by dispersing each material in an aqueous medium. Each material is dispersed by a known method, and for example, a media type dispersing machine such as a rotary shear type homogenizer, a ball mill, a sand mill, or an attritor, and a high pressure counter collision type dispersion machine can be suitably used. Further, a surfactant or a polymer dispersing agent, which imparts dispersion stability, can be added to the dispersion liquid as necessary.

Examples of the aggregating agent include metal salts of monovalent metals such as sodium and potassium, metal salts of divalent metals such as calcium and magnesium, metal salts of trivalent metals such as iron aluminum, and polyvalent metal salts such as polyaluminum chloride. From the viewpoint of particle diameter controllability in the aggregation step, metal salts of divalent metals such as calcium chloride and magnesium sulfate can be suitably used.

The aggregating agent can be added and mixed in a temperature range of room temperature to 75° C. In a case where the aggregating agent is added and mixed in the above-described temperature range, the aggregation proceeds in a stable state. The aggregating agent can be mixed using a known mixing device, homogenizer, or mixer.

### Fusion Step

The fusion step is a step of heating and fusing the aggregate particles suitably at a temperature higher than or equal to the melting point of an olefin-based resin to produce particles obtained by making the surface of the aggregate particles smooth.

Before the fusion step, a chelating agent, a pH adjuster, a surfactant, or the like can be appropriately added to the particles to prevent melt-adhesion between the obtained resin particles.

Examples of the chelating agent include alkali metal salts of ethylenediaminetetraacetic acid (EDTA) and the Na salt thereof, sodium gluconate, sodium tartrate, potassium citrate, sodium citate, nitrilotriacetate (NTA) salt, and various water-soluble polymers (polyelectrolytes) having functionality of both COOH and OH.

The fusion step requires a shorter time when the heating temperature increases and requires a longer time when the heating temperature decreases. That is, the time for heat fusion depends on the heating temperature and thus cannot be generally defined, but is typically in a range of 10 minutes to 10 hours.

### Cooling Step:

The cooling step is a step of decreasing the temperature of the aqueous medium containing the resin particles obtained in the fusion step. The cooling rate is not particularly limited, but specifically, is in a range of 0.1 to 50° C./min.

### Cleaning Step:

The resin particles prepared by performing the above-described steps can be repeatedly cleaned and filtered to remove impurities in the resin particles.

Specifically, the resin particles can be washed with an aqueous solution containing a chelating agent such as ethylenediaminetetraacetic acid (EDTA) or the Na salt thereof and further washed with pure water.

The metal salts, the surfactant, and the like in the resin particles can be removed by repeatedly washing the resin particles with pure water and filtering the resin particles a plurality of times. The number of times of filtration is preferably in a range of 3 to 20 from the viewpoint of the production efficiency and more preferably in a range of 3 to 10.

### Drying and Classification Step

The washed resin particles can be dried and appropriately classified to obtain toner particles.

### Dissolution Suspension Method

The toner particles to be produced by the dissolution suspension method are produced, for example, in the following manner.

In the dissolution suspension method, the resin composition obtained by dissolving binder resin components such as a polyester resin and a styrene acrylic resin in an organic solvent is dispersed in an aqueous medium to granulate the particles of the resin composition, and the organic solvent contained in the particles of the resin composition is removed, thereby preparing the toner particles.

The dissolution suspension method can be applied in a case where the resin components are dissolved in an organic solvent, and the shape can be controlled by adjusting the conditions during desolvation.

Hereinafter, the method of producing the toner using the dissolution suspension method will be described in detail, but the present disclosure is not limited thereto.

### Resin Component Dissolution Step:

In the resin component dissolution step, the resin composition is prepared by dissolving or dispersing the binder resin and as necessary, other components such as a colorant, wax, and silicone oil in an organic solvent.

Any solvent can be used as the organic solvent to be used as long as the organic solvent can dissolve the resin components. Specific examples thereof include toluene, xylene, chloroform, methylene chloride, and ethyl acetate. Further, toluene and ethyl acetate can be suitably used from the viewpoints of promotion of crystallization of the crystalline resin and ease of removing the solvent.

The amount of the organic solvent to be used is not limited, and may be an amount set such that the viscosity in which the resin composition can be dispersed in a poor solvent such as water and granulated is obtained. Specifically, the mass ratio between the resin component and as necessary, other components such as a colorant, wax, and silicone oil to the organic solvent can be set to be in a range of 10/90 to 50/50 from the viewpoints of the granulation properties and the production efficiency of the toner particles.

Meanwhile, the colorant, wax, and silicone oil are not necessarily in a state of being dissolved in an organic solvent and may be dispersed therein. In a case where the colorant, wax, and silicone oil are used in a dispersed state, the colorant, wax, and silicone oil can be dispersed using a dispersing machine such as a bead mill.

### Granulation Step

The granulation step is a step of dispersing the obtained resin composition in an aqueous medium using a dispersing agent such that a predetermined toner particle diameter is obtained, to prepare particles of the resin composition.

Water is mainly used as the aqueous medium.

Further, the aqueous medium can contain 1% by mass or greater and 30% by mass or less of a monovalent metal salt. In a case where the aqueous medium contains a monovalent metal salt, the organic solvent in the resin composition is suppressed from being diffused into the aqueous medium, and the crystallinity of the resin component contained in the obtained toner particles is increased.

As a result, the blocking resistance of the toner is likely to be enhanced, and the particle size distribution of the toner is likely to be enhanced.

Examples of the monovalent metal salt include sodium chloride, potassium chloride, lithium chloride, and potassium bromide. Among these, sodium chloride and potassium chloride can be used.

Further, the mixing ratio (mass ratio) of the aqueous medium to the resin composition (aqueous medium/resin composition) can be set to be in a range of 90/10 to 50/50.

The dispersing agent is not particularly limited, and a cationic surfactant, an anionic surfactant, and a nonionic surfactant can be used as the organic dispersing agent. Among these, an anionic surfactant can be used. Examples thereof include sodium alkylbenzene sulfonate, sodium α-olefin sulfonate, sodium alkyl sulfonate, and sodium alkyl diphenyl ether disulfonate. Meanwhile, examples of the inorganic dispersing agent include tricalcium phosphate, hydroxyapatite, calcium carbonate fine particles, titanium oxide fine particles, and silica fine particles.

Among these, tricalcium phosphate serving as the inorganic dispersing agent can be suitably used from the viewpoint that the adverse effects on the granulation properties, the stability thereof, and the characteristics of the toner to be obtained are extremely small.

The amount of the dispersing agent to be added is determined according to the particle diameter of the granulated material, and the particle diameter decreases as the amount of the dispersing agent to be added increases. Therefore, the amount of the dispersing agent to be added varies depending on a desired particle diameter, but can be set to 0.1% by mass or greater and 15.0% by mass or less with respect to the amount of the resin composition.

Further, In a case where particles of the resin composition are prepared in an aqueous medium, the preparation can be performed under a condition of high-speed shearing. Examples of a device that provides high-speed shearing include various high-speed dispersing machines and various ultrasonic dispersing machines.

### Desolvation Step

In the desolvation step, the organic solvent contained in the particles of the obtained resin composition is removed to produce the toner particles. The organic solvent may be removed while the mixture is stirred.

### Washing, Drying, and Classification Step:

After the desolvation step, the toner particles may be subjected to a washing and drying step of washing the toner particles with water or the like a plurality of times and filtering and drying the toner particles. Further, the toner particles can be washed with water after being washed with hydrochloric acid or the like when a dispersing agent that is dissolved under acidic conditions such as tricalcium phosphate is used as the dispersing agent. The dispersing agent used for granulation can be removed by washing the toner particles. The toner particles are washed, filtered, dried, and classified as appropriate, thereby obtaining the toner particles.

### Suspension Polymerization Method

The toner particles are, for example, produced by the suspension polymerization method in the following manner.

A polymerizable monomer composition is prepared by uniformly dissolving or dispersing a polymerizable monomer that generates a binder resin, and a colorant, a wax component, a polymerization initiator, and the like using a homogenizer, a ball mill, or a dispersing machine such as an ultrasonic dispersing machine. The polymerizable monomer composition is dispersed in an aqueous medium to granulate the particles of the polymerizable monomer composition, and the polymerizable monomers in the particles formed of the polymerizable monomer composition are polymerized, thereby obtaining the toner particles.

In this case, the polymerizable monomer composition can be prepared by mixing a dispersion liquid obtained by dispersing a colorant in a first polymerizable monomer (or some of the polymerizable monomers) with at least a second polymerizable monomer (or the remaining polymerizable monomers). That is, the colorant is allowed to be in a state of being sufficiently dispersed in the first polymerizable monomer and mixed with other toner materials and the second polymerizable monomer, and thus the colorant can be present in the toner particles in a more satisfactory dispersed state.

The obtained toner particles may be filtered, washed, dried, and classified by known methods as necessary.

### Step of Adding External Additive to Toner Particles

The toner can be obtained by mixing the toner particles obtained by the method as described above and the external additive in a Henschel mixer.

The weight-average particle diameter (D4) of the toner is preferably 4.0 μm or greater and 15.0 μm or less, more preferably 4.0 μm or greater and 9.0 μm or less, and still more preferably 6.0 μm or greater and 8.0 μm or less.

The weight-average particle diameter (D4) of the toner can be adjusted, for example, by classifying the toner particles.

The toner concentration in the two-component developer is preferably 2% by mass or greater and 15% by mass or less and more preferably 4% by mass or greater and 13% by mass or less in terms of the mixing ratio between the toner and the carrier. The image density is enhanced in a case where the toner concentration is 2% by mass or greater, and fogging and scattering inside the machine can be suppressed in a case where the toner concentration is 15% by mass or less.

### Method of Measuring Various Physical Properties

Methods of measuring various physical properties will be described below.

Separation of Composite Particles from Toner

Each physical property can also be measured by the following method using composite particles separated from the toner.

200 g of sucrose (manufactured by Kishida Chemical Co., Ltd.) is added to 100 mL of ion exchange water and dissolved in a hot water bath, thereby preparing a concentrated sucrose solution. 31 g of the concentrated sucrose solution and 6 mL of Contaminon N (10 mass % aqueous solution of neutral detergent for washing precision measuring machine with pH of 7, which is formed of nonionic surfactant, anionic surfactant, and organic builder, manufactured by FUJIFILM Wako Pure Chemical Corporation) are poured into a centrifuge tube to prepare a dispersion liquid. 1 g of the toner is added to this dispersion liquid, and the toner clumps are broken up with a spatula or the like.

The centrifuge tube is set in a shaker and shaken at 350 strokes per minute for 20 minutes. After the shaking, the solution is transferred to a glass tube (50 mL) for a swing rotor and centrifuged in a centrifuge under conditions of 3,500 rpm for 30 minutes. In the glass tube after the centrifugation, the toner is present in the uppermost layer, and the fine particles are present in the underlayer on the aqueous solution side. The aqueous solution of the underlayer is collected and centrifuged to separate the sucrose and the fine particles so that the fine particles are collected. As necessary, the centrifugation is repeated to sufficiently carry out the separation, the dispersion liquid is dried, and the composite particles are collected.

In a case where a plurality of external additives are added, the composite particles can be sorted out by using a centrifugation method or the like.

### Method of Measuring Embedment Ratio of Fine Particles B

The composite fine particles are sufficiently dispersed in a visible light-curable resin (trade name, ARONIX LCR Series D-800, manufactured by TOAGOSEI CO., LTD.) and irradiated with short-wavelength light to be cured. The obtained cured product is cut out using an ultramicrotome provided with a diamond knife to prepare flaky samples with a size of 250 nm. Next, the cut-out samples are magnified at a magnification of 40000 times to 50000 times using a transmission electron microscope (electron microscope JEM-2800, manufactured by JEOL Ltd.) (TEM-EDX) to observe cross sections of the composite fine particles. The diameter of the fine particle B and the depth of the fine particle B embedded in the fine particle A are measured from the cross-sectional image. Five fine particles B are randomly selected for one composite fine particle, and the embedment ratios of the fine particles B are calculated. Further, the number of external additive particles to be analyzed is set to 20 particles or more, and the average value of the calculated embedment ratios is set to the embedment ratio of the fine particles B.

$$Embedment ratio ( \% ) of fine particle B = ( depth of fine particle B embedded in fine particle A / diameter of fine particle B ) \times 100$$

### Method of Measuring Content Proportions of Constituent Compounds of Fine Particles A and Composite Particles by Solid-State ²⁹Si-NMR

In solid-state ²⁹Si-NMR, peaks are detected in different shift regions depending on the structures of the functional groups bonded to Si of the constituent compounds of the fine particles A and the composite particles. The structure bonded to Si can be specified by specifying the position of each peak using a standard sample. Further, the abundance ratio of each constituent compound can be calculated from the obtained peak area. The proportions of the peak areas of an M unit structure, a D unit structure (unit (c)), a T unit structure (unit (b), and a Q unit structure (unit (a)) in the total peak area can be determined by calculation.

Specifically, the conditions for measuring solid-state ²⁹Si-NMR are as follows.
Device: JNM-ECX5002 (JEOL RESONANCE)
Temperature: room temperature
Measuring method: DDMAS method, ²⁹Si 45°
Sample tube: zirconia with diameter of 3.2 mmϕ
Sample: test tube is filled with sample in powder state
Sample rotation speed: 10 kHz
Relaxation delay: 180 s
Scan: 2000

In a case where the fine particles B are required to be separated from the composite particles, the separation of the fine particles B can be performed in the following manner.

First, the composite particles are added to and dispersed in a solution with a pH of 12 to 14. Gaps are formed at the interface between the fine particles A and the fine particles B by performing a strong alkali treatment. Thereafter, only the fine particles B can be separated using the specific gravity by performing a centrifugation operation.

After the measurement, a plurality of silane components having different substituents and bonding groups of the sample are peak-separated into the M unit structure, the D unit structure (c), the T unit structure (b), and the Q unit structure (a) by curve fitting, and each peak area is calculated.

The curve fitting is performed using EXcalibur for Windows (registered trademark) version 4.2 (EX series) of software for JNM-EX400 (manufactured by JEOL, Ltd.). “1D Pro” is clicked from the menu icon to read the measurement data. Next, the curve fitting is performed by selecting “Curve fitting function” from “Command” of the menu bar. The curve fitting is performed for each component such that a difference (composite peak difference) between a composite peak obtained by combining each peak obtained by the curve fitting and a peak of the measurement result is minimized.

Further, a separation treatment is performed on the peaks corresponding to the structures represented by Formulae (a), (b), and (c) to obtain the above-described peaks PD1, PT1, PT2, PQ1, PQ2, and PQ3. Peak areas SD1, ST1, ST2, SQ1, SQ2, and SQ3 are calculated from each of the peaks. In addition, in a case where the structures are required to be confirmed in more detail, the measurement results of ²⁹Si-NMR and the measurement results of 13C-NMR and 1H-NMR are used in combination to identify the structures.

### Method of Measuring Fixing Ratio of External Additive

A method of measuring the fixing ratio of the external additive will be described. First, the amount of the external additive contained in the toner before the water washing treatment is quantified. The Si element intensity in the toner is measured using a wavelength dispersive X-ray fluorescence analyzer Axios Advanced (manufactured by PANalytical). Next, the Si element intensity in the toner after the water washing treatment is measured in the same manner as described above. The fixing ratio (%) can be calculated by the following equation.

$$Fixing ratio ( \% ) = ( Si element intensity in toner after water washing treatment / Si element intensity in toner before water washing treatment ) \times 100$$

### Measurement of Number Average Particle Diameter of External Additive

The number average particle diameter of the external additive can be determined by observing the toner particles using a scanning electron microscope (SEM) and measuring the numbers and the particle diameters (maximum diameters) of the composite fine particles and the fine particles C present on the surface of the toner particles. In this case, an energy dispersive X-ray analyzer (EDS) attached to the SEM is used to confirm that the measurement target is the composite fine particles or the fine particles C. Further, 100 toner particles are measured, and the average value thereof is defined as the number average particle diameter.

### Method of Measuring Weight-Average Particle Diameter (D4) of Toner

The weight-average particle diameter (D4) of the toner is measured by 25,000 effective measuring channels using a precision particle size distribution measuring device “COULTER COUNTER Multisizer 3” (registered trademark, manufactured by Beckman Coulter, Inc.) provided with an aperture tube having a diameter of 100 μm by an aperture impedance method and dedicated software “BECKMAN COULTER Multisizer 3 Version 3.51” (manufactured by Beckman Coulter, Inc.) attached to the device for setting measurement conditions and analyzing measurement data, and calculated by analyzing measurement data.

An electrolyte solution obtained by dissolving special grade sodium chloride in ion exchange water and adjusting the concentration thereof to about 1% by mass, for example, “ISOTON II” (manufactured by Beckman Coulter, Inc.) can be used as the electrolyte solution used for the measurement.

In addition, dedicated software is set up in the following manner before the measurement and the analysis.

In dedicated software “screen for changing standard measuring method (SOM)”, the total count number in the control mode is set to 50,000 particles, the number of times of measurement is set to once, and a value obtained by using “nominal particle 10.0 μm” (manufactured by Beckman Coulter, Inc.) is set as the Kd value. The threshold value and the noise level are automatically set by pressing the measurement button of the threshold value/noise level. Further, the current is set to 1,600 μA, the gain is set to 2, the electrolyte solution is set to ISOTON II, and the aperture tube flash after measurement is checked.

In dedicated software “setting screen for converting pulse to particle diameter”, the bin interval is set to the logarithmic particle diameter, the particle diameter bin is set to 256 particle diameter bin, and the particle diameter range is set to 2 μm or greater and 60 μm or less.

The specific measuring method is as follows.
(1) A 250 mL round-bottom glass beaker for exclusive use of Multisizer 3 is charged with about 200 mL of the electrolyte solution and set on a sample stand, and the solution is stirred with a stirrer rod at 24 rotations/sec in a counterclockwise direction. Further, the stain and air bubbles inside the aperture tube are removed by the function of the dedicated software “aperture tube flash”.
(2) A 100 ml flat-bottom glass beaker is charged with about 30 mL of the electrolyte solution, and about 0.3 mL of a diluent obtained by diluting “Contaminon N” (10 mass % aqueous solution of neutral detergent for washing precision measuring machine with pH of 7, which is formed of nonionic surfactant, anionic surfactant, and organic builder, manufactured by FUJIFILM Wako Pure Chemical Corporation) to 3 times by mass with ion exchange water is added thereto as a dispersing agent.
(3) A predetermined amount of ion exchange water is poured into a water tank of an ultrasonic disperser “Ultrasonic Dispersion System Tetora 150” (manufactured by Nikkaki Bios Co., Ltd.) with an electrical output of 120 W, which is provided with two built-in oscillators having an oscillation frequency of 50 kHz in a state of a phase shift of 180 degrees, and about 2 mL of Contaminon N is added to the water tank.
(4) The beaker of the item (2) is set in a beaker fixing hole of the ultrasonic disperser, and the ultrasonic disperser is operated. Further, the position of the height of the beaker is adjusted such that the resonance state of the liquid level of the electrolyte solution in the beaker is maximized.
(5) The electrolyte solution in the beaker of the item (4) is irradiated with ultrasonic waves, and about 10 mg of the toner is added to the electrolyte solution little by little and dispersed therein. Further, an ultrasonic dispersion treatment is further continued for 60 seconds. In addition, the water temperature in the water tank is appropriately adjusted to 10° C. or higher and 40° C. or lower in the ultrasonic dispersion treatment.
(6) The electrolyte solution of the item (5) in which the toner has been dispersed using a pipette is added dropwise to the round-bottom beaker of the item (1) disposed in the sample stand, and the measurement concentration is adjusted to about 5%.

Further, the measurement is performed until the number of measured particles reaches 50,000.
(7) The weight-average particle diameter (D4) is calculated by analyzing the measurement data using the dedicated software attached to the device. Further, “average diameter” of the analysis/volume statistics (arithmetic average) screen is the weight-average particle diameter (D4) in a case where the graph/vol % is set with the dedicated software.

### Measurement of Ester Group Concentration

The ester group concentration in the present disclosure is the concentration of the ester group in the acrylic resin, and defined by the following equation.

$$[ Ester group concentration ( mmol / g ) ] = [ number of moles of ester group in acrylic moiety ] / [ \text{} molecular weight of acrylic moiety ]$$

The acrylic resin is typically obtained by radically polymerizing (meth)acrylic acid ester having a double bond. Therefore, the number of moles and the molecular weight of the ester group of the acrylic resin can be calculated from the number of moles and the molecular weight of the (meth)acrylic acid ester serving as a raw material.

First, the ester group concentration is determined from the coating resin of the present disclosure by placing the magnetic carrier in a cup, eluting the coating resin using toluene, removing the magnetic carrier core, drying and solidifying the eluted resin, and separating the coating resin. The separated coating resin is analyzed by pyrolysis GC/MS to estimate the constituent monomer, and the ester group concentration is calculated from the results.

In a case where two or more kinds of constituent monomers are present, the ester group concentration is calculated by calculating the molar ratio of the constituent monomers by 1H-NMR measurement using deuterated chloroform.

### EXAMPLES

Hereinafter, the present disclosure will be described in more detail with reference to examples, but the present disclosure is not limited thereto. Further, parts in the following formulations are on a mass basis unless otherwise specified.

### Production Example of Binder Resin 1

Bisphenol A-ethylene oxide (2.2-mole adduct): 50.0 parts by mole
Bisphenol A-propylene oxide (2.2-mole adduct): 50.0 parts by mole
Terephthalic acid: 90.0 parts by mole
Trimellitic anhydride: 10.0 parts by mole

100 parts of the monomers constituting a polyester unit were mixed with 500 ppm of titanium tetrabutoxide in a 5 L autoclave.

A reflux condenser, a moisture separator, a N2 gas introduction tube, a thermometer, and a stirrer were provided for the autoclave, and a polycondensation reaction was carried out at 230° C. while N2 gas was introduced into the autoclave. The reaction time was adjusted such that a desired softening point was obtained. After completion of the reaction, the monomers were taken out from the container, cooled, and pulverized, thereby obtaining a binder resin 1. The binder resin 1 had a softening point of 130° C. and a Tg of 57° C.

The softening point was measured in the following manner.

### Measurement of Softening Point

The softening point was measured using a constant load extrusion type capillary rheometer “flow characteristic evaluation device Flow Tester CFT-500D” (manufactured by Shimadzu Corporation) according to the manual attached to the device. In this device, a measurement sample filling a cylinder was heated and melted while a constant load was applied thereto from above the measurement sample by a piston, the melted measurement sample was extruded from a die at the bottom portion of the cylinder, and a flow curve showing the relationship between the piston drop amount and the temperature was obtained.

“Melting point in ½ method” described in the manual attached to “flow characteristic evaluation device Flow Tester CFT-500D” was used as the softening point.

Further, the melting temperature in the ½ method was calculated in the following manner.

First, half a difference between a piston drop amount Smax at the time when the outflow ended and a piston drop amount Smin at the time when outflow was started was determined (the obtained value was defined as X, X=(Smax−Smin)/2). Further, the temperature on the flow curve when the piston drop amount on the flow curve reached the sum of X and Smin was defined as the melting temperature in the ½ method.

A measurement sample obtained by compression-molding about 1.3 g of a sample at 10 MPa for 60 seconds using a tablet compression molding machine (for example, NT-100H, manufactured by NPa SYSTEM CO., LTD.) in an environment of 25° C. to have a columnar shape with a diameter of about 8 mm was used as the measurement sample. The measurement conditions for CFT-500D are as follows.
Test mode: temperature increasing method
Starting temperature: 50° C.
Reaching temperature: 200° C.
Measurement interval: 1.0° C.
Temperature increasing rate: 4.0° C./min
Piston cross-sectional area: 1.000 cm²
Test load (piston load): 10.0 kgf/cm² (0.9807 MPa)
Preheating time: 300 sec
Diameter of die hole: 1.0 mm
Length of die: 1.0 mm

### Production Example of Composite Particles 1

### 1. Hydrolysis and Polycondensation Step:

(1) A 500 mL beaker was charged with 21.6 g of RO water, 135.0 g of methanol, 0.004 g of acetic acid serving as a catalyst, and 12.2 g of dimethyldimethoxysilane, and the mixture was stirred at 45° C. for 5 minutes.
(2) 2.0 g of 28% ammonia water, 15.0 g of tetraethoxysilane, and 5.0 g of a colloidal silica aqueous dispersion liquid A (silica solid content: 40% by mass, number average particle diameter of silica: 40 nm (0.04 μm)) were added to the mixture, and the resulting mixture was stirred at 30° C. for 3.0 hours, thereby obtaining a raw material solution.

### 2. Particle-Forming Step:

A 1000 ml beaker was charged with 120.0 g of RO water, the raw material solution obtained in the hydrolysis and polycondensation step was added dropwise to the RO water over 5 minutes while the mixture was stirred at 25° C. Thereafter, the mixed solution was heated to 60° C. and stirred for 1.5 hours while being maintained at 60° C., thereby obtaining a dispersion liquid of external additive fine particles.

### 3. Hydrophobization Step:

6.0 g of hexamethyldisilazane was added as a hydrophobizing agent to the dispersion liquid of the external additive fine particles obtained in the particle-forming step, and the solution was stirred at 60° C. for 3.0 hours. The solution was allowed to stand for 5 minutes, the powder precipitated at a lower portion of the solution was recovered by suction filtration and dried at 120° C. for 24 hours under reduced pressure, thereby obtaining composite particles 1. The number average particle diameter of the primary particles of the composite particles 1 was 0.12 μm.

### Production Example of Composite Particles 2

Composite particles 2 were obtained in the same manner as in the production example of the composite particles 1 except that an alumina aqueous dispersion liquid (alumina solid content: 30% by mass, number average particle diameter of alumina: 40 nm (0.04 μm)) was used in place of the colloidal silica aqueous dispersion liquid A in the item (2) of the hydrolysis and polycondensation step described above. The number average particle diameter of the primary particles of the composite particles 2 was 0.12 μm.

### Production Example of Composite Particles 3

Composite particles 3 were obtained in the same manner as in the production example of the composite particles 1 except that 7.0 g of a titanium oxide aqueous dispersion liquid (titanium oxide solid content: 30% by mass, number average particle diameter of titanium oxide: 40 nm (0.04 μm)) was used in place of the colloidal silica aqueous dispersion liquid A in the item (2) of the hydrolysis and polycondensation step described above. The number average particle diameter of the primary particles of the composite particles 3 was 0.12 μm.

### Production Example of Composite Particles 4

Composite particles 4 were obtained in the same manner as in the production example of the composite particles 1 except that the amount of the dimethyldimethoxysilane was changed to 5.4 g in the item (1) of the hydrolysis and polycondensation step, and the amount of the tetraethoxysilane was changed to 8.2 g, and 13.6 g of trimethoxymethylsilane was added in the item (2) of the hydrolysis and polycondensation step described above. The number average particle diameter of the primary particles of the composite particles 4 was 0.12 μm.

### Production Example of Composite Particles 5

Composite particles 5 were obtained in the same manner as in the production example of the composite particles 1 except that 25.3 g of trimethoxymethylsilane was added without adding dimethyldimethoxysilane in the item (1) of the hydrolysis and polycondensation step, and the amount of the tetraethoxysilane was changed to 1.9 g in the item (2) of the hydrolysis and polycondensation step described above.

The number average particle diameter of the primary particles of the composite particles 5 was 0.12 μm.

### Production Example of Composite Particles 6

Composite particles 6 were obtained in the same manner as in the production example of the composite particles 1 except that the amount of the 28% ammonia water was changed to 1.0 g and the stirring temperature was changed to 25° C. in the item (2) of the hydrolysis and polycondensation step described above. The number average particle diameter of the primary particles of the composite particles 6 was 0.12 μm.

### Production Example of Composite Particles 7

Composite particles 7 were obtained in the same manner as in the production example of the composite particles 1 except that the stirring temperature was changed to 35° C. in the item (2) of the hydrolysis and polycondensation step described above. The number average particle diameter of the primary particles of the composite particles 7 was 0.12 μm.

### Production Example of Composite Particles 8

Composite particles 8 were obtained in the same manner as in the production example of the composite particles 1 except that the amount of the 28% ammonia water was changed to 3.0 g and the stirring temperature was changed to 35° C. in the item (2) of the hydrolysis and polycondensation step described above. The number average particle diameter of the primary particles of the composite particles 8 was 0.12 μm.

### Production Example of Composite Particles 9

Composite particles 9 were obtained in the same manner as in the production example of the composite particles 1 except that a colloidal silica aqueous dispersion liquid B (silica solid content: 40% by mass, number average particle diameter of silica: 10 nm (0.01 μm)) was used in place of the colloidal silica aqueous dispersion liquid A, the amount of the 28% ammonia water was changed to 1.0 g, the stirring temperature was changed to 45° C., and the stirring time was changed to 4.5 hours in the item (2) of the hydrolysis and polycondensation step described above. The number average particle diameter of the primary particles of the composite particles 9 was 0.03 μm.

### Production Example of Composite Particles 10

Composite particles 10 were obtained in the same manner as in the production example of the composite particles 1 except that the amount of the 28% ammonia water was changed to 3.0 g and the stirring temperature was changed to 25° C. in the item (2) of the hydrolysis and polycondensation step described above. The number average particle diameter of the primary particles of the composite particles 10 was 0.30 μm.

### Production Example of Composite Particles 12

Composite particles 12 were obtained in the same manner as in the production example of the composite particles 1 except that the amount of the 28% ammonia water was changed to 0.5 g and the stirring temperature was changed to 25° C. in the item (2) of the hydrolysis and polycondensation step described above. The number average particle diameter of the primary particles of the composite particles 12 was 0.12 μm.

### Production Example of Composite Particles 13

### 1. Hydrolysis and Polycondensation Step:

(1) A 500 mL beaker was charged with 21.6 g of RO water, 135.0 g of methanol, 0.004 g of acetic acid serving as a catalyst, and 12.2 g of dimethyldimethoxysilane, and the mixture was stirred at 45° C. for 5 minutes.
(2) 2.0 g of 28% ammonia water and 15.0 g of tetraethoxysilane were added to the mixture, and the mixture was stirred at 30° C. for 2.0 hours.
(3) 5.0 g of a colloidal silica aqueous dispersion liquid A (silica solid content: 40% by mass, particle diameter: 40 nm) was added to the mixture, and the resulting mixture was stirred for 10 minutes, thereby obtaining a raw material solution.

### 2. Particle-Forming Step:

A 1000 ml beaker was charged with 120.0 g of RO water, the raw material solution obtained in 1. Hydrolysis and polycondensation step described above was added dropwise to the RO water over 5 minutes while the mixture was stirred at 25° C. Thereafter, the mixed solution was heated to 60° C. and stirred for 1.5 hours while being maintained at 60° C., thereby obtaining a dispersion liquid of external additive fine particles.

### 3. Hydrophobization Step:

6.0 g of hexamethyldisilazane was added as a hydrophobizing agent to the dispersion liquid of the external additive fine particles obtained in 2. Particle-forming step described above, and the solution was stirred at 60° C. for 3.0 hours. The solution was allowed to stand for 5 minutes, the powder precipitated at a lower portion of the solution was recovered by suction filtration and dried at 120° C. for 24 hours under reduced pressure, thereby obtaining composite particles 11. The number average particle diameter of the primary particles of the composite particles 11 was 0.12 μm.

### Production Example of Composite Particles 14

Composite particles 14 were obtained in the same manner as in the production example of the composite particles 1 except that a colloidal silica aqueous dispersion liquid B (silica solid content: 40% by mass, number average particle diameter of silica: 10 nm (0.01 μm)) was used in place of the colloidal silica aqueous dispersion liquid A, the amount of the 28% ammonia water was changed to 1.0 g, the stirring temperature was changed to 45° C., and the stirring time was changed to 4.0 hours in the item (2) of the hydrolysis and polycondensation step described above. The number average particle diameter of the primary particles of the composite particles 14 was 0.02 μm.

### Production Example of Composite Particles 15

Composite particles 15 were obtained in the same manner as in the production example of the composite particles 1 except that the amount of the 28% ammonia water was changed to 5.0 g and the stirring temperature was changed to 25° C. in the item (2) of the hydrolysis and polycondensation step described above. The number average particle diameter of the primary particles of the composite particles 15 was 0.33 μm.

### Production Example of Composite Particles 11

A 250 mL four-neck round-bottom flask equipped with an overhead stirring motor, a condenser, and a thermocouple was charged with 18.7 g of a colloidal silica dispersion liquid (silica solid content: 40% by mass, number average particle diameter of silica: 30 nm (0.03 μm)), 125 mL of DI water, and 16.5 g (0.066 mol) of methacryloxypropyl-trimethoxysilane. The temperature was increased to 65° C., and the mixture was stirred at 120 rpm. Nitrogen gas was allowed to pass through the mixture to be bubbled for 30 minutes. After 3 hours, 0.16 g of a 2,2′-azobisisobutyronitrile radical initiator which had been dissolved in 10 mL of ethanol was added to the mixture, and the temperature was increased to 75° C.

The radical polymerization was allowed to proceed for 5 hours, and 3 mL of 1,1,1,3,3,3-hexamethyldisilazane was added to the mixture. The reaction was further allowed to proceed for 3 hours. The final mixture was filtered through a 170-mesh sieve to remove a coagulated material, the dispersion liquid was dried in a Pyrex (registered trademark) dish at 120° C. overnight, thereby obtaining composite particles 11.

The number average particle diameter of the primary particles of the composite particles 11 was 0.12 μm.

Each of the physical properties of the composite particles 1 to 15 obtained above and inorganic fine particles 1 is listed in Table 1. Further, colloidal silica having a number average particle diameter of 0.10 μm was used as the inorganic fine particles 1.

TABLE 1

| | Content | | | | | | | | |
|---|---|---|---|---|---|---|---|---|---|
| | proportion | | | | | | | Number | |
| | of fine | | | Expression | | | | average | Middle |
| | particles A | | | (1) | Expression | Fine | Embedment | particle | part in |
| | (%) | | | Xa + | (2) | particles | ratio | diameter | Expression |
| | Xa | Xb | Xc | Xb + Xc | Xb + Xc | B | (%) | (μm) | (9) |
| Composite | 40 | 0 | 60 | 100 | 60 | Silica | 65 | 0.12 | 0.200 |
| particles 1 | | | | | | | | | |
| Composite | 40 | 0 | 60 | 100 | 60 | Alumina | 65 | 0.12 | 0.200 |
| particles 2 | | | | | | | | | |
| Composite | 40 | 0 | 60 | 100 | 60 | Titanium | 65 | 0.12 | 0.200 |
| particles 3 | | | | | | oxide | | | |
| Composite | 30 | 50 | 20 | 100 | 70 | Silica | 65 | 0.12 | 0.200 |
| particles 4 | | | | | | | | | |
| Composite | 7 | 93 | 0 | 100 | 93 | Silica | 65 | 0.12 | 0.200 |
| particles 5 | | | | | | | | | |
| Composite | 40 | 0 | 60 | 100 | 60 | Silica | 65 | 0.12 | 0.300 |
| particles 6 | | | | | | | | | |
| Composite | 40 | 0 | 60 | 100 | 60 | Silica | 65 | 0.12 | 0.170 |
| particles 7 | | | | | | | | | |
| Composite | 40 | 0 | 60 | 100 | 60 | Silica | 65 | 0.12 | 0.110 |
| particles 8 | | | | | | | | | |
| Composite | 40 | 0 | 60 | 100 | 60 | Silica | 65 | 0.03 | 0.300 |
| particles 9 | | | | | | | | | |
| Composite | 40 | 0 | 60 | 100 | 60 | Silica | 65 | 0.30 | 0.300 |
| particles 10 | | | | | | | | | |
| Composite | 0 | 0 | 0 | 0 | 0 | Silica | 65 | 0.12 | 0.002 |
| particles 11 | | | | | | | | | |
| Composite | 40 | 0 | 60 | 100 | 60 | Silica | 65 | 0.12 | 0.320 |
| particles 12 | | | | | | | | | |
| Composite | 40 | 0 | 60 | 100 | 60 | Silica | 20 | 0.12 | 0.200 |
| particles 13 | | | | | | | | | |
| Composite | 40 | 0 | 60 | 100 | 60 | Silica | 65 | 0.02 | 0.300 |
| particles 14 | | | | | | | | | |
| Composite | 40 | 0 | 60 | 100 | 60 | Silica | 65 | 0.32 | 0.300 |
| particles 15 | | | | | | | | | |
| Inorganic fine | 100 | 0 | 0 | 100 | 0 | — | — | 0.12 | 0.168 |
| particles 1 | | | | | | | | | |

Production Example of toner 1
Binder resin 1: 100 parts
Paraffin resin (melting point of 78° C.): 4 parts
C.I. Pigment Blue 15:3: 4 parts

The above-described materials were pre-mixed in a Henschel mixer (trade name: FM-10C type, manufactured by NIPPON COKE & ENGINEERING CO., LTD.) and melt-kneaded with a twin-screw kneading extruder at 160° C. The obtained kneaded material was cooled, coarsely pulverized in a hammer mill, and finely pulverized in a turbo mill. The obtained finely pulverized material was classified with a multi-division classifier using the Coanda effect, thereby obtaining toner base particles 1 having a weight-average particle diameter (D4) of 6.5 μm.

Next, the obtained toner base particles 1 were subjected to an external addition treatment as described below.
Toner base particles 1: 100 parts
Composite particles 1: 3.0 parts

The above-described materials were mixed in a Henschel mixer (trade name: FM-10C type, manufactured by NIPPON COKE & ENGINEERING CO., LTD.) at a rotation speed of 67 s⁻¹ (4000 rpm), a rotation time of 2 min, and an external addition temperature of room temperature, and allowed to pass through an ultrasonic vibration sieve having an opening size of 54 μm, thereby obtaining a toner 1.

### Production Examples of Toners 2 to 24

Toners 2 to 24 were obtained in the same manner as in the production example of the toner 1 except that the external addition conditions were changed such that the fixing ratios were set to the values listed in Table 2 and the types of the particles and the addition amounts thereof were changed as listed in Table 2.

TABLE 2

| | | Amount of composite | Fixing |
|---|---|---|---|
| | | particles added | ratio |
| | Type of particles | (parts) | (%) |
| Toner 1 | Composite particles 1 | 3.00 | 80 |
| Toner 2 | Composite particles 1 | 3.00 | 90 |
| Toner 3 | Composite particles 1 | 3.00 | 50 |
| Toner 4 | Composite particles 1 | 3.00 | 95 |
| Toner 5 | Composite particles 1 | 3.00 | 45 |
| Toner 6 | Composite particles 2 | 3.00 | 80 |
| Toner 7 | Composite particles 3 | 3.00 | 80 |
| Toner 8 | Composite particles 1 | 0.10 | 80 |
| Toner 9 | Composite particles 1 | 10.00 | 80 |
| Toner 10 | Composite particles 1 | 0.08 | 80 |
| Toner 11 | Composite particles 1 | 10.50 | 80 |
| Toner 12 | Composite particles 4 | 3.00 | 80 |
| Toner 13 | Composite particles 5 | 3.00 | 80 |
| Toner 14 | Composite particles 6 | 3.00 | 80 |
| Toner 15 | Composite particles 7 | 3.00 | 80 |
| Toner 16 | Composite particles 8 | 3.00 | 80 |
| Toner 17 | Composite particles 9 | 3.00 | 80 |
| Toner 18 | Composite particles 10 | 3.00 | 80 |
| Toner 19 | Composite particles 11 | 3.00 | 80 |
| Toner 20 | Composite particles 12 | 3.00 | 80 |
| Toner 21 | Composite particles 13 | 3.00 | 80 |
| Toner 22 | Composite particles 14 | 3.00 | 80 |
| Toner 23 | Composite particles 15 | 3.00 | 80 |
| Toner 24 | Inorganic fine particles 1 | 3.00 | 80 |

Production Example of magnetic carrier cores 1
Step 1 (weighing and mixing step):
Fe₂O₃: 68.3 parts by mass
MnCO₃: 28.5% by mass
Mg(OH)₂: 2.0% by mass
SrCO₃: 1.2% by mass

The above-described ferrite raw materials were weighed. 20 parts of water was added to 80 parts of the ferrite raw materials, and the mixture was wet-mixed in a ball mill for 3 hours using zirconia having a diameter ($) of 10 mm, thereby preparing a slurry. The solid content concentration of the slurry was set to 80% by mass.

### Step 2 (Pre-Calcination Step):

The mixed slurry was dried with a spray dryer (manufactured by OHKAWARA KAKOHKI CO., LTD.) and calcined in a batch type electric furnace at a temperature of 1050° C. for 3.0 hours in a nitrogen atmosphere (oxygen concentration of 1.0% by volume), thereby preparing a pre-calcined ferrite.

### Step 3 (Pulverization Step)

The pre-calcined ferrite was pulverized to a size of about 0.5 mm using a crusher, and water was added thereto to prepare a slurry. The solid content concentration of the slurry was set to 70% by mass. The slurry was pulverized in a wet ball mill using ⅛ inch stainless steel beads for 3 hours to obtain a slurry. Further, this slurry was pulverized in a wet bead mill using zirconia having a diameter of 1 mm for 4 hours, thereby obtaining a pre-calcined ferrite slurry having a 50% particle diameter (D50) of 1.3 μm based on volume distribution.

### Step 4 (Granulation Step)

1.0 parts of ammonium polycarbonate serving as a dispersing agent and 1.5 parts of polyvinyl alcohol serving as a binder were added to 100 parts of the pre-calcined ferrite slurry, and the mixture was granulated into spherical particles and dried using a spray dryer (manufactured by OHKAWARA KAKOHKI CO., LTD.). The particle size of the obtained granulated material was adjusted, and the resultant was heated in a rotary electric furnace at 700° C. for 2 hours, and organic matter such as the dispersing agent, the binder, and the like was removed.

### Step 5 (Calcination Step)

The time required for increasing the temperature from room temperature to the calcination temperature (1100° C.) was set to 2 hours, the particles were maintained at a temperature of 1100° C. for 4 hours in a nitrogen atmosphere (oxygen concentration of 1.0% by volume) and calcined. Thereafter, the temperature was decreased to 60° C. over 8 hours, the nitrogen atmosphere was returned to the air atmosphere, and the particles were taken out at a temperature of 40° C. or lower.

### Step 6 (Sorting Step)

The aggregated particles were crushed and sieved through a sieve having an opening size of 150 μm to remove coarse particles, fine particles were removed by wind force classification, and low magnetic particles were removed by magnetic separation, thereby obtaining porous magnetic core particles 1.

100 parts of the porous magnetic core particles 1 were placed in a stirring container of a mixing stirrer (universal stirrer NDMV type, manufactured by Dalton Corporation), the temperature was maintained at 60° C., and 5 parts of a filling resin formed of 95.0% by mass of a methyl silicone oligomer and 5.0% by mass of γ-aminopropyltrimethoxysilane was added dropwise to the particles at a normal pressure.

After completion of the dropwise addition, the mixture was continuously stirred while the time was adjusted, and heated to 70° C., and the particles of each porous magnetic core were filled with the resin composition.

The resin-filled magnetic core particles obtained after being cooled were transferred to a mixer (UD-AT type drum mixer, manufactured by Sugiyama Heavy Industrial Co., Ltd.) having a spiral blade in a rotatable mixing container, and heated to 140° C. while being stirred at a temperature increasing rate of 2° C./min in a nitrogen atmosphere. Thereafter, the particles were continuously heated and stirred at 140° C. for 50 minutes.

Thereafter, the particles were cooled to room temperature, the ferrite particles filled with the resin and cured were taken out, and non-magnetic matter was removed using a magnetic separator. Further, coarse particles were removed by a vibration sieve, thereby obtaining magnetic carrier cores 1 filled with the resin.

### Production Example of Magnetic Carrier Cores 2

The raw materials were weighed such that the amounts of MnO, MgO, Fe₂O₃, and SrO were respectively set to 35% by mole, 14.5% by mole, 50% by mole, and 0.5% by mole, mixed with water, and pulverized in a wet media mill for 5 hours to obtain a slurry. The obtained slurry was dried with a spray dryer, thereby obtaining true-spherical particles. The particles were heated at 950° C. for 2 hours, pre-calcined, pulverized in a wet ball mill using stainless steel beads having a diameter of 0.5 cm for 1 hour, and further pulverized using zirconia beads having a diameter of 0.3 cm for 4 hours. An appropriate amount of a dispersing agent was added to this slurry, 0.8% by mass of a polyvinyl alcohol resin (PVA) was added as a binder with respect to the solid content for the purpose of ensuring the strength of the particles granulated, and the mixture was granulated with a spray dryer, dried, maintained in an electric furnace at a temperature of 1275° C. at an oxygen concentration of 2.5% by volume (nitrogen gas atmosphere) for 5 hours, and subjected to main calcination. Thereafter, the mixture was crushed and further classified to adjust the particle size, and a low-magnetic product was separated by magnetic separation, thereby obtaining magnetic carrier cores 2.

### Production Example of Magnetic Carrier Cores 3

4.0 parts of a silane-based coupling agent (3-(2-aminoethylamino) propyltrimethoxysilane) was added to 100.0 parts of magnetite powder (magnetite A) having a number average particle diameter of 0.30 μm, and the mixture was mixed and stirred in a container at 100° C. or higher and at a high speed to treat the magnetite A.
Phenol: 10 parts
Formaldehyde solution: 6 parts
   (40% of formaldehyde, 10% of methanol, and 50% of water)
Treated magnetite A: 84 parts

The above-described materials, 5 parts of 28% ammonia water, and 20 parts of water were placed in a flask, heated to 85° C. for 30 minutes and maintained at the temperature while being stirred and mixed, and allowed to undergo a polymerization reaction for 3 hours, and the phenolic resin generated was cured. Thereafter, the cured phenolic resin was cooled to 30° C., water was further added thereto, the supernatant was removed, and the precipitate was washed with water and air-dried. Next, the resultant was dried at 60° C. under reduced pressure (5 mmHg or less), thereby obtaining magnetic carrier cores 3 in a state where the magnetic material was dispersed.

### Production Example of Magnetic Carriers 1

Cyclohexyl methacrylate: 75.8 parts
Methyl methacrylate: 5.4 parts
Methyl methacrylate macromonomer: 32.7 parts

The above-described raw materials (total amount of 109.0 parts) were added to a four-neck flask provided with a reflux condenser, a thermometer, a nitrogen suction tube, and a griding type stirrer, 100.0 parts of toluene, 100.0 parts of methyl ethyl ketone, and 2.4 parts of azobisisovaleronitrile were added thereto, and the mixture was maintained at 80° C. for 10 hours in a nitrogen stream, thereby obtaining a coating resin.
Magnetic carrier cores 1: 100 parts
Coating resin: 2 parts

The above-described number of parts of the coating resin with respect to 100 parts of the magnetic carrier cores 1 was diluted with toluene such that the proportion of the resin component reached 5%, and the solution was sufficiently stirred to prepare a resin solution. Thereafter, the magnetic carrier cores 1 were placed in a planetary motion type mixer (VN type NAUTA MIXER, manufactured by Hosokawa Micron Corporation) maintained at a temperature of 60° C., and the above-described resin solution was poured into the mixer. As a method of pouring the resin solution, half the amount of the resin solution was poured into the mixer, the solvent was removed for 30 minutes, and a coating operation was performed. Next, half the amount of the resin solution was further poured into the mixture, the solvent was removed for 40 minutes, and the coating operation was performed.

Thereafter, the magnetic carriers coated with the resin coated layer were transferred to a mixer (UD-AT type drum mixer, manufactured by Sugiyama Heavy Industrial Co., Ltd.) having a spiral blade in a rotatable mixing container, and subjected to a heat treatment at 120° C. for 2 hours in a nitrogen atmosphere while being stirred by allowing the mixing container to rotate 10 times for 1 minute. The obtained magnetic carriers were subjected to magnetic separation to separate the low-magnetic product, allowed to pass through a sieve having an opening size of 150 μm, and classified with a pneumatic classifier, thereby obtaining magnetic carriers 1.

### Production Examples of Magnetic Carriers 2 to 17

Magnetic carriers 2 to 17 were obtained in the same manner as in the production example of the magnetic carriers 1 except that the types of the materials and the amounts of the materials added were changed as listed in Table 3. Further, the ratio between NMA and AA of the coated resins of the magnetic carriers 13 were set to 9:1 in terms of the molar ratio.

Further, the magnetic carriers 15 were obtained by using a commercially available silicone resin (SR2410, manufactured by Dow Corning Toray Silicone Co., Ltd.) without synthesizing a coating resin. Further, the magnetic carriers 17 were used without coating the magnetic carrier cores 3 with the coating resin.

TABLE 3

| | Magnetic | | Ester group | Amount of |
|---|---|---|---|---|
| | carrier | | concentration β | coated resin |
| | cores | Coated resin | (mmol/g) | (parts) |
| Magnetic carriers 1 | 1 | CHMA + MMA | 7.2 | 2.0 |
| Magnetic carriers 2 | 2 | CHMA + MMA | 7.2 | 2.0 |
| Magnetic carriers 3 | 3 | CHMA + MMA | 7.2 | 1.5 |
| Magnetic carriers 4 | 3 | CHMA + MMA | 7.2 | 0.5 |
| Magnetic carriers 5 | 3 | CHMA + MMA | 7.2 | 3.5 |
| Magnetic carriers 6 | 3 | CHMA + MMA | 7.2 | 0.3 |
| Magnetic carriers 7 | 3 | CHMA + MMA | 7.2 | 4.0 |
| Magnetic carriers 8 | 3 | CHMA | 6.0 | 1.5 |
| Magnetic carriers 9 | 3 | 2-EHMA | 5.0 | 1.5 |
| Magnetic carriers 10 | 3 | MMA | 10.0 | 1.5 |
| Magnetic carriers 11 | 3 | NMA | 4.7 | 1.5 |
| Magnetic carriers 12 | 3 | MA | 11.5 | 1.5 |
| Magnetic carriers 13 | 3 | NMA + AA | 4.5 | 1.5 |
| Magnetic carriers 14 | 3 | AA | — | 1.5 |
| Magnetic carriers 15 | 3 | Silicone resin | — | 1.5 |
| Magnetic carriers 16 | 3 | St | — | 1.5 |
| Magnetic carriers 17 | 3 | — | — | — |

CHMA: cyclohexyl methacrylate
MMA: methyl methacrylate
2-EHMA: 2-ethylhexyl methacrylate
NMA: nonyl methacrylate
MA: methyl acrylate
AA: acrylic acid
St: styrene
Two-component developers 1 to 41

The toners 1 to 24 and the magnetic carriers 1 to 17 were used, and each material was shaken in a shaker (YS-8D type; manufactured by Yayoi Corporation) such that the toner concentration reached 8% by mass to prepare 300 g of each two-component developer. The amplitude conditions of the shaker were set to 200 rpm and 2 minutes. The details of the two-component developers 1 to 41 are listed in Table 4.

TABLE 4

| Two-component developer | Toner | Magnetic carriers | β/α |
|---|---|---|---|
| 1 | 1 | 1 | 36.0 |
| 2 | 1 | 2 | 36.0 |
| 3 | 1 | 3 | 36.0 |
| 4 | 2 | 3 | 36.0 |
| 5 | 3 | 3 | 36.0 |
| 6 | 4 | 3 | 36.0 |
| 7 | 5 | 3 | 36.0 |
| 8 | 6 | 3 | 36.0 |
| 9 | 7 | 3 | 36.0 |
| 10 | 8 | 3 | 36.0 |
| 11 | 9 | 3 | 36.0 |
| 12 | 10 | 3 | 36.0 |
| 13 | 11 | 3 | 36.0 |
| 14 | 1 | 4 | 36.0 |
| 15 | 1 | 5 | 36.0 |
| 16 | 1 | 6 | 36.0 |
| 17 | 1 | 7 | 36.0 |
| 18 | 12 | 3 | 36.0 |
| 19 | 13 | 3 | 36.0 |
| 20 | 1 | 8 | 30.0 |
| 21 | 14 | 9 | 16.7 |
| 22 | 15 | 10 | 58.8 |
| 23 | 16 | 10 | 90.9 |
| 24 | 14 | 11 | 15.7 |
| 25 | 15 | 12 | 67.8 |
| 26 | 16 | 12 | 104.5 |
| 27 | 14 | 13 | 15.0 |
| 28 | 14 | 14 | — |
| 29 | 14 | 15 | — |
| 30 | 15 | 15 | — |
| 31 | 16 | 15 | — |
| 32 | 17 | 15 | — |
| 33 | 18 | 15 | — |
| 34 | 19 | 15 | — |
| 35 | 20 | 15 | — |
| 36 | 21 | 15 | — |
| 37 | 22 | 15 | — |
| 38 | 23 | 15 | — |
| 39 | 1 | 16 | — |
| 40 | 1 | 17 | — |
| 41 | 24 | 17 | — |

### Examples 1 to 33 and Comparative Examples 1 to 8

The following evaluations were performed using the obtained two-component developers.

A modified color copier imagePRESS C850 (manufactured by CANON INC.) was used as an image forming apparatus. The two-component developer was placed in each color developing device to form images, and various evaluations were performed in an endurance test.

An FFH output chart with a predetermined image ratio was used for the endurance test under the following printing tests. FFH denotes a value expresses 256 gradations in hexadecimal, 00h is the first gradation (white background portion) of the 256 gradations, FFH is the 256th gradation (solid portion) of the 256 gradations.

### Conditions

### Image Forming Speed: A4 Size, Full Color, 100 Sheets/Min

Development conditions: The copier was modified such that the development contrast was adjustable to any value and the automatic correction function did not work by the main body. The modification was also made such that the peak-to-peak voltage (Vpp) of the alternating electric field had a frequency of 2.0 kHz and the Vpp was changed from 0.7 kV to 1.8 kV at an interval of 0.1 kV. Further, the modification was also made such that an image of each single color could be output.

The modification was made such that carrier replacement (auto refresh mechanism) of the two-component developer in the developing device did not occur during the endurance test.

Each of the evaluation items is as follows.

### (1) White Spots

The endurance test was performed by outputting 100,000 images using an FFH output chart with an image ratio of 5% in a printing environment of a temperature of 23° C./a humidity of 5 RH % (hereinafter, referred to as “N/L”). After completion of the endurance test, the development conditions were adjusted such that the solid (FFh) density on paper was set to 1.4 using an X-Rite color reflection densitometer (500 series; manufactured by X-Rite, Inc.) for the image density. As the number of white spots, 17 gradations (00h to FFh, each horizontal band 10 mm×290 mm) were output on A4 size paper, and the number of white spots that had occurred was counted.

Plain copy paper CS-814 (A4 size, basis weight of 81.4 g/m², sold by Canon Marketing Japan Inc.) was used as the evaluation paper.

### Evaluation Criteria

A: The number of white spots was 0 or more and less than 3.
B: The number of white spots was 3 or more and less than 6.
C: The number of white spots was 6 or more and less than 10.
D: The number of white spots was 10 or more and less than 20.
E: The number of white spots was 20 or more.

### (2) Evaluation of On-Surface Uniformity

The endurance test was performed by outputting 100,000 images using an FFH output chart with an image ratio of 30% in a printing environment of a temperature of 30° C./a humidity of 80 RH % (hereinafter, referred to as “H/H”). After completion of the endurance test, a screen halftone image with an average reflection density of 0.80 was output on A3 size paper, and the on-surface uniformity was evaluated.

Plain copy paper CS-814 (A4 size, basis weight of 81.4 g/m², sold by Canon Marketing Japan Inc.) was used as the evaluation paper.

The image density was measured at 45 sites on one sheet of paper using a spectrodensitometer (500 series, manufactured by X-Rite, Inc.), and the variation was evaluated based on the standard deviation according to the following evaluation criteria.

### Evaluation Criteria

A: The standard deviation was less than 0.020.
B: The standard deviation was 0.020 or greater and less than 0.040.
C: The standard deviation was 0.040 or greater and less than 0.060.
D: The standard deviation was 0.060 or greater and less than 0.080.
E: The standard deviation was 0.080 or greater.

The evaluation results described above are listed in Table 5. In each of the above-described evaluation items, the two-component developers without the items evaluated as E were determined to be satisfactory.

TABLE 5

| | Two- | White spots | | On-surface uniformity | |
|---|---|---|---|---|---|
| | component | | Evalua- | Standard | Evalua- |
| | developer | Number | tion | deviation | tion |
| Example 1 | 1 | 0 | A | 0.009 | A |
| Example 2 | 2 | 0 | A | 0.012 | A |
| Example 3 | 3 | 0 | A | 0.011 | A |
| Example 4 | 4 | 1 | A | 0.020 | B |
| Example 5 | 5 | 1 | A | 0.021 | B |
| Example 6 | 6 | 3 | B | 0.021 | B |
| Example 7 | 7 | 3 | B | 0.022 | B |
| Example 8 | 8 | 1 | A | 0.023 | B |
| Example 9 | 9 | 3 | B | 0.023 | B |
| Example 10 | 10 | 1 | A | 0.023 | B |
| Example 11 | 11 | 1 | A | 0.024 | B |
| Example 12 | 12 | 4 | B | 0.026 | B |
| Example 13 | 13 | 4 | B | 0.026 | B |
| Example 14 | 14 | 2 | A | 0.027 | B |
| Example 15 | 15 | 2 | A | 0.030 | B |
| Example 16 | 16 | 4 | B | 0.031 | B |
| Example 17 | 17 | 4 | B | 0.033 | B |
| Example 18 | 18 | 2 | A | 0.033 | B |
| Example 19 | 19 | 4 | B | 0.035 | B |
| Example 20 | 20 | 2 | A | 0.014 | A |
| Example 21 | 21 | 2 | A | 0.037 | B |
| Example 22 | 22 | 2 | A | 0.039 | B |
| Example 23 | 23 | 4 | B | 0.040 | C |
| Example 24 | 24 | 5 | B | 0.041 | C |
| Example 25 | 25 | 5 | B | 0.044 | C |
| Example 26 | 26 | 6 | C | 0.051 | C |
| Example 27 | 27 | 7 | C | 0.061 | D |
| Example 28 | 28 | 8 | C | 0.064 | D |
| Example 29 | 29 | 8 | C | 0.067 | D |
| Example 30 | 30 | 9 | C | 0.068 | D |
| Example 31 | 31 | 11 | D | 0.071 | D |
| Example 32 | 32 | 18 | D | 0.074 | D |
| Example 33 | 33 | 10 | D | 0.078 | D |
| Comparative | 34 | 12 | D | 0.080 | E |
| Example 1 | | | | | |
| Comparative | 35 | 13 | D | 0.082 | E |
| Example 2 | | | | | |
| Comparative | 36 | 15 | D | 0.086 | E |
| Example 3 | | | | | |
| Comparative | 37 | 21 | E | 0.083 | E |
| Example 4 | | | | | |
| Comparative | 38 | 10 | D | 0.085 | E |
| Example 5 | | | | | |
| Comparative | 39 | 16 | D | 0.090 | E |
| Example 6 | | | | | |
| Comparative | 40 | 19 | D | 0.091 | E |
| Example 7 | | | | | |
| Comparative | 41 | 23 | E | 0.095 | E |
| Example 8 | | | | | |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-079335, filed May 15, 2024, which is hereby incorporated by reference herein in its entirety.

What is claimed is:

1. A two-component developer comprising:
a toner; and
a magnetic carrier,
wherein the magnetic carrier includes a magnetic carrier core and a resin coated layer that covers a surface of the magnetic carrier core, and
the resin coated layer has at least one structure selected from the group consisting of a structure represented by Formula (A), a structure represented by Formula (B), and a structure represented by Formula (C), 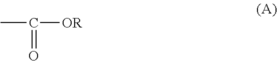
in Formula (A), R represents an alkyl group having 1 or more and 10 or less carbon atoms, 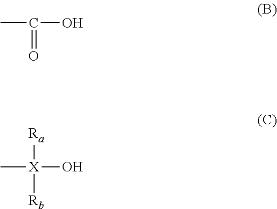
in Formula (C), X represents a carbon atom or a silicon atom, and Rₐ and R_{b} each independently represent a hydrogen atom or an alkyl group having 1 or more and 10 or less carbon atoms,
the toner is a toner including a composite particle on a surface of a toner particle,
the composite particle includes
a fine particle A that uses, as a binder component, an organic silicon compound having a siloxane bond, and
a fine particle B that is present in a state of being partially embedded in a surface of the fine particle A,
the composite particle is formed of a primary particle having a number average particle diameter of 0.03 μm or greater and 0.30 μm or less,
in DD-MAS measurement of solid-state ²⁹Si-NMR of the fine particle A, in a case where a proportion of silicon atoms present in a state of the following unit (a) in all silicon atoms is defined as Xa (%), a proportion of silicon atoms present in a state of the following unit (b) in all silicon atoms is defined as Xb (%), and a proportion of silicon atoms present in a state of the following unit (c) is defined as Xc (%), content proportions of Xa, Xb, and Xc satisfy Expressions (1) and (2),
$$Xa + Xb + Xc \geq 80 \% \qquad ( 1 )$$
$$Xb + Xc \geq 30 \% \qquad ( 2 )$$ 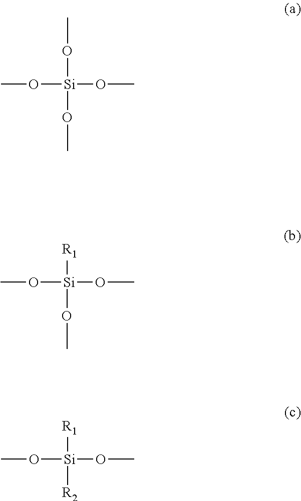
in Formulae (b) and (c), R₁ and R₂ each independently represent an alkyl group having 1 or more and 6 or less carbon atoms,
in the fine particle B of the composite particle, an average value of an embedment ratio represented by the following equation is 30% or greater and 90% or less,
$$embedment ratio ( \% ) of fine particle B = ( depth of fine particle B embedded in fine particle A / diameter of fine particle B ) \times 100$$
in DD-MAS measurement of solid-state ²⁹Si-NMR of the composite particle, a peak PD1 corresponding to a silicon atom represented by Si^{a} in a structure represented by Formula (3), a peak PT1 corresponding to a silicon atom represented by Si^{b} in a structure represented by Formula (4), a peak PT2 corresponding to a silicon atom represented by Si^{c} in a structure represented by Formula (5), a peak PQ1 corresponding to a silicon atom represented by Si^{d} in a structure represented by Formula (6), a peak PQ2 corresponding to a silicon atom represented by Si^{e} in a structure represented by Formula (7), and a peak PQ3 corresponding to a silicon atom represented by Si^{f} in a structure represented by Formula (8) are observed, and
in a case where an area of the peak PD1 is defined as SD1, an area of the peak PT1 is defined as ST1, an area of the peak PT2 is defined as ST2, an area of the peak PQ1 is defined as SQ1, an area of the peak PQ2 is defined as SQ2, an area of the peak PQ3 is defined as SQ3, and an area of all peaks corresponding to all silicon atoms is defined as SSi, Expression (9) is satisfied, 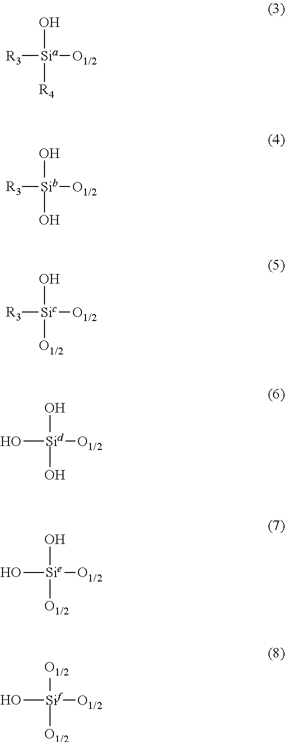
in Formulae (3) to (5), R₃ and R₄ each independently represent an alkyl group having 1 or more and 6 or less carbon atoms,
$$0.1 \leq \frac{SD 1}{SSi} + \frac{2 \times ST 1}{SSi} + \frac{ST 2}{SSi} + \frac{3 \times SQ 1}{SSi} + \frac{2 \times SQ 2}{SSi} + \frac{SQ 3}{SSi} \leq 0.3 . \qquad ( 9 )$$

2. The two-component developer according to claim 1,
wherein the peaks SD1, ST1, ST2, SQ1, SQ2, SQ3, and SSi satisfy Expression (10),
$$0.17 \leq \frac{SD 1}{SSi} + \frac{2 \times ST 1}{SSi} + \frac{ST 2}{SSi} + \frac{3 \times SQ 1}{SSi} + \frac{2 \times SQ 2}{SSi} + \frac{SQ 3}{SSi} \leq 0.3 . \qquad ( 10 )$$

3. The two-component developer according to claim 1,
wherein the resin coated layer has a structure represented by Formula (A).

4. The two-component developer according to claim 1,
wherein the resin coated layer has a structure represented by Formula (A), and
the resin coated layer has an ester group concentration of 5.0 mmol/g or greater and 11.0 mmol/g or less.

5. The two-component developer according to claim 1,
wherein the resin coated layer has a structure represented by Formula (A), and
the resin coated layer is formed of a copolymer of monomers including a (meth)acrylic acid ester monomer containing an alicyclic hydrocarbon group or a (meth)acrylic acid monomer containing an alkyl group having 1 or more and 8 or less carbon atoms.

6. The two-component developer according to claim 1,
wherein the resin coated layer has a structure represented by Formula (A), and
in a case where a value of a middle part in Expression (9) is defined as a, and an ester group concentration of the resin coated layer is defined as β (mmol/g), Expression (11) is satisfied,
$$16. \leq β / α \leq 100.0 . \qquad ( 11 )$$

7. The two-component developer according to claim 1,
wherein the proportions Xa, Xb, and Xc satisfy Expressions (12), (13), and (14),
$$30 \% \leq Xa / ( Xa + Xb + Xc ) \leq 80 \% \qquad ( 12 )$$
$$0 \% \leq Xb / ( Xa + Xb + Xc ) \leq 50 \% \qquad ( 13 )$$
$$20 \% \leq Xc / ( Xa + Xb + Xc ) \leq 70 \% . \qquad ( 14 )$$

8. The two-component developer according to claim 1,
wherein the magnetic carrier contains 0.5 parts by mass or greater and 3.5 parts by mass or less of the resin coated layer with respect to 100 parts by mass of the magnetic carrier core particle.

9. The two-component developer according to claim 1,
wherein the toner contains 0.1 parts by mass or greater and 10.0 parts by mass or less of the composite particle with respect to 100 parts by mass of the toner particle.

10. The two-component developer according to claim 1,
wherein the fine particle B is a silica fine particle or an alumina fine particle.

11. The two-component developer according to claim 1,
wherein a fixing ratio of the composite particle onto the surface of the toner particle is 50% or greater and 90% or less.
